(19) United States
(12) Patent Application Publication
(10) Pub. No.: US 2024/0216741 A1
(43) Pub. Date: Jul. 4, 2024

(54) DEVICE FOR ASSISTING WITH SHOULDER MOTION

(71) Applicant: c/o ERMI LLC, Atlanta, GA (US)

(72) Inventors: Thomas P. Branch, Atlanta, GA (US); Shaun Kevin Stinton, Chamblee, GA (US); Edward Dittmar, Marietta, GA (US); Matei Dan, Salt Lake City, UT (US); Garrick Edward Dittmar, Marietta, GA (US); Jared Alexander Dittmar, Marietta, GA (US)

(21) Appl. No.: 18/557,720

(22) PCT Filed: Apr. 27, 2022
(86) PCT No.: PCT/US2022/026609

§ 371 Date: Oct. 27, 2023

Related U.S. Application Data
(60) Provisional application No. 63/180,515, filed on Apr. 27, 2021.

(51) Int. Cl. A63B 21/00; A61H 1/02

(52) U.S. Cl. CPC A63B 21/00181; A61H 1/0281; A61H 2201/0107; A61H 2201/0149; A61H 2201/0192; A61H 2201/1215; A61H 2201/1638; A61H 2201/1676; A61H 2203/0431

(57) ABSTRACT

Embodiments of the invention are directed to devices and methods for providing shoulder forward flexion, abduction, external rotation, and internal rotation stretch assistance. A device for manipulating an arm of a user, thereby providing abduction or flexion assistance to a shoulder of the user includes an engagement mechanism configured to operatively couple with the user's arm and configured to pivot about an axis defined by the gleno-humeral joint of the shoulder as the shoulder abducts or flexes; a scapular restriction mechanism restricts movement of a scapula of the user's shoulder during a first phase of abduction or flexion and to move in an anatomically correct ratio with gleno-humeral motion during a second phase of abduction or flexion; and a force application system operatively coupled with the engagement mechanism, and configured to apply a force to the engagement mechanism, providing the abduction or flexion assistance to the arm about the shoulder.

### FIELD OF THE INVENTION

The present invention is generally directed to orthopedic devices and more particularly to orthopedic devices designed to improve and promote gains in range of motion in a shoulder joint.

### BACKGROUND

When a joint is damaged either from an injury event or through surgical intervention, scar tissue may form and limit the motion of the joint. This loss of motion can greatly affect a person's quality of life by limiting their ability to accomplish their normal activities of daily living. Traditionally, orthopedic devices designed to help recover joint range of motion are separated into two categories: braces or orthotics that can be worn to support and protect limbs or large mechanical devices that are designed to allow a seated application of force at the level of a therapist.

Different joints are capable of moving in different directions, and the full range of motion of a joint depends upon the anatomy of that joint and on the particular genetics of each individual. Joint motion can generally be classified as rotation perpendicular to the long axis of the limb directed towards the side, e.g., Flexion and extension of the knee, rotation parallel to the long axis of the joint, e.g., Internal and external rotation of the knee, or rotation perpendicular to the long axis of the limb directed forward, e.g., Varus and valgus of the knee. While a joint may have a predominant axis of rotation, motion around the other axes are important for the full function of the joint.

Conventional orthotic devices designed to recover lost motion have attempted to provide support across a joint while being worn. They utilize a rigid member or hinged joint and apply a force around one major axis to encourage return of motion. Human limbs are shaped such that a worn orthotic device has difficulty controlling undesirable motions off axis to the important major axis for motion return. Orthopedic devices in the form of a seated mechanical system allow for directed force application while allowing off axis control of motion. The control of “off axis” motion allows an improvement in the directed force and increased safety for the patient.

It has been shown that orthotic devices that are meant to be worn on the extremity cannot supply the same amount of force for motion recovery as orthopedic devices in the form of a seated mechanical system.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing methods and devices that assist shoulder flexion, abduction, external rotation, and internal rotation. Embodiments of the device provide for manipulating an arm of a user, thereby providing abduction or flexion assistance to a shoulder of the user. The device includes an engagement mechanism configured to operatively couple with the user's arm and configured to pivot about an axis defined by the gleno-humeral joint of the shoulder as the shoulder abducts or flexes; a scapular restriction mechanism configured to restrict movement of a scapula of the user's shoulder during a first phase of abduction or flexion and to move in a an approximately anatomically correct 1:2 ratio with gleno-humeral motion during a second phase of abduction or flexion; and a force application system operatively coupled with the engagement mechanism, and configured to apply a force to the engagement mechanism, thereby providing the abduction or flexion assistance to the arm about the shoulder.

Embodiments of the invention also provide for a method for manipulating a user's arm, thereby providing abduction or flexion assistance to an shoulder of the user, the method comprising engaging the arm of the user with an engagement mechanism configured to pivot about an axis defined by the gleno-humeral joint of the shoulder as the arm extends or flexes about the shoulder; restricting movement of a scapula of the shoulder during a first phase of movement and allowing movement of the scapula during a second phase of movement in an approximately anatomically correct ratio of gleno-humeral motion to scapular motion; and activating a force application mechanism to apply an incremental force to the engagement mechanism, thereby creating a torque about the axis through the gleno-humeral joint of the shoulder and causing abduction or flexion of the user's arm about the shoulder of the user.

In some embodiments, the approximately anatomically correct ratio is approximately 1:2 scapular to gleno-humeral motion during the second phase of abduction or flexion.

In some embodiments, the force application system comprises an abduction rotary actuator configured to apply rotational force to the engagement mechanism to cause the engagement mechanism to move in abduction.

In some embodiments, the force application system comprises an external/internal rotary actuator configured to apply rotational force to the engagement mechanism to cause the engagement mechanism to move in external rotation or internal rotation.

In some embodiments, the force application system comprises a lower rotary actuator configured to apply rotational force to the engagement mechanism to cause the engagement mechanism to move in external rotation or internal rotation.

According to embodiments of the invention, a device for manipulating an arm of a user, thereby providing abduction, forward flexion, external rotation, and internal rotation assistance to a shoulder of the user, includes an engagement mechanism configured to operatively couple with the user's arm and configured to pivot about an axis defined by the gleno-humeral joint of the shoulder as the shoulder abducts or flexes; a chair platform configured to operatively couple with a folding chair; a swivel hinge operatively coupled with the chair platform; and an upright operatively coupled with the swivel hinge, wherein the swivel hinge is configured to enable the upright to swivel from a first position wherein the device is configured to enable abduction to a second position wherein the device is configured to enable forward flexion.

In some such embodiments, the device includes (a) a rotary actuator operatively coupled to the chair platform and configured to apply rotational force to the hinge to cause the device to swivel from the first position to the second position and vice versa as controlled by the user.

In some embodiments of the invention, a method for manipulating an arm of a user, thereby providing abduction, forward flexion, external rotation, and internal rotation assistance to a shoulder of the user using a device having an engagement mechanism configured to operatively couple with the user's arm includes pivoting an arm of the user, using the engagement mechanism, about an axis defined by the gleno-humeral joint of the shoulder as the shoulder abducts or flexes; and changing the engagement mechanism from a first position wherein the device is configured to enable abduction to a second position wherein the device is configured to enable forward flexion.

In some embodiments, the changing comprises swiveling the engagement mechanism from the first position to the second position.

In some such embodiments, the swiveling is performed by applying a rotary force using a rotary actuator.

In some embodiments, the method also includes (a) pivoting an arm of the user in external rotation or internal rotation by applying a rotary force using a rotary actuator.

In some such embodiments, the rotary actuator is operatively coupled with a swivel hinge operatively coupled with an upright operatively coupled with the engagement mechanism.

In some embodiments, the rotary actuator is operatively coupled proximate a distal end of an upper arm of the engagement mechanism.

In some embodiments, the swiveling is performed by applying a force using a linear actuator.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A is a depiction of a shoulder joint.

FIG. 1B is a depiction of the scapula-humeral rhythm.

FIG. 2 provides a cross-sectional view of a portion of one embodiment of a device for assisting with flexion and abduction of the shoulder.

FIGS. 3A-3J illustrate a device 300 for assisting with shoulder motion is shown in an arm-bent, thirty (30) degree abduction configuration 301.

FIGS. 3K-3M illustrate the device 300 in an arm-bent, ninety (90) degree abduction configuration 302.

FIGS. 4A-4J illustrate the device 300 in an arm-bent, sixty (60) degree abduction, one-hundred five (105) degree external rotation configuration 400.

FIGS. 5A-5J illustrate the device 300 in an arm-bent, sixty (60) degree abduction, one hundred five (105) degree internal rotation configuration 500.

FIGS. 6A-6C illustrate the device 300 in an arm-straight, ninety (90) degree abduction configuration 600.

FIGS. 6D-6F illustrate the device 300 in an arm-straight, one-hundred seventy (170) degree abduction configuration 602.

FIGS. 7A-7J illustrate the device 300 in a forward flexion configuration 700 and a straight-arm, forward flexion starting position 702.

FIGS. 7K-7M illustrate the device 300 in a forward flexion configuration 700 and a straight-arm, forward flexion ending position 704.

FIGS. 8A and 8B illustrate a two-switch and a three-switch control system for the device according to embodiments of the invention.

FIG. 8C illustrates a diagram of the control system for the device according to embodiments of the invention.

FIG. 9A is a close-up illustration of a cam-actuated shoulder device according to embodiments of the invention.

FIGS. 9B-9E are illustrations of a cam-actuated shoulder device according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Like numbers refer to like elements throughout.

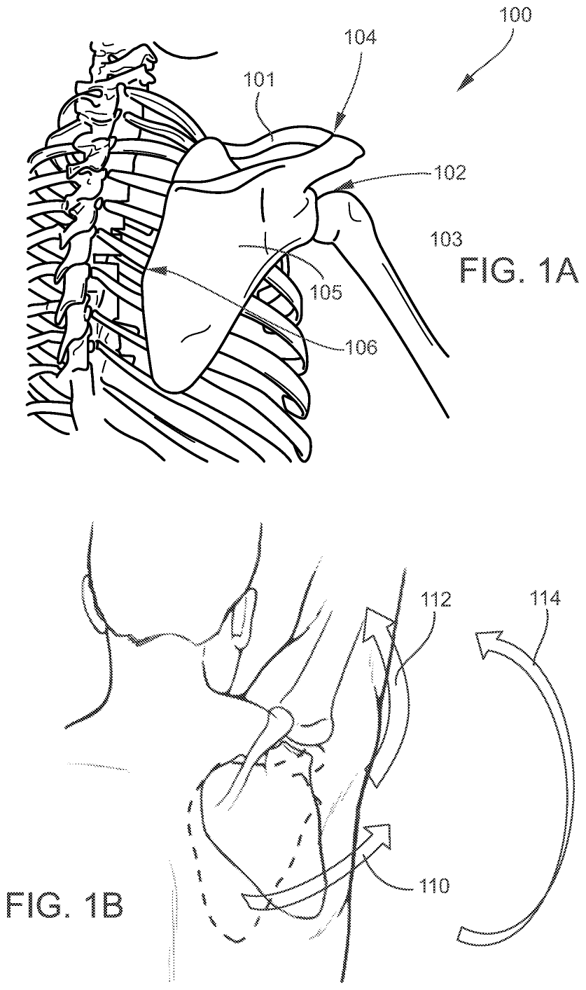

Embodiments of the invention provide methods and devices for enabling a staged stretch for a person's shoulder joint 100, which is a complex joint joining the clavicle 101, the humerus 103 and the scapula 105. The shoulder joint 100 includes the glenohumeral joint 102, the AC joint 104, and the scapulothoracic joint 106 as shown in FIG. 1A.

In certain embodiments of the invention, the stretch is focused on the glenohumeral motion for the first portion of the stretch and then for a second portion of the stretch, allowing the scapula to move freely or move in an anatomically correct ratio, such as a 2:1 ratio of glenohumeral motion to scapular motion throughout the remainder of the movement. In different people, the ratio varies from 2:1, and therefore, different embodiments of the invention provide for adjustment of the system to account for different user anatomies and ratios of glenohumeral to scapular motion. A number of studies have indicated that glenohumeral motion dominates in the first 30-60 degrees of flexion and abduction and that the 2:1 ratio of glenohumeral motion to scapular motion represents natural shoulder motion. This motion, known as scapula-humeral rhythm or gleno-humeral rhythm is shown in FIG. 1B. In other words, in scapula-humeral rhythm, the scapula and humerus move in a 1:2 ratio. When the arm is abducted one-hundred eighty (180) degrees of motion as represented by arrow 114, that motion is provided by sixty (60) degrees of scapular rotational motion as represented by arrow 110 by rotation of the scapula, and one-hundred twenty (120) degrees by rotation of the humerus as represented by arrow 112 at the shoulder joint 100. It should be noted that the scapula rotates on a different axis (or path) of motion than the humerus and the gleno-humeral joint, and so the approximations of relative movement are in reference to different points/axes/frames of reference.

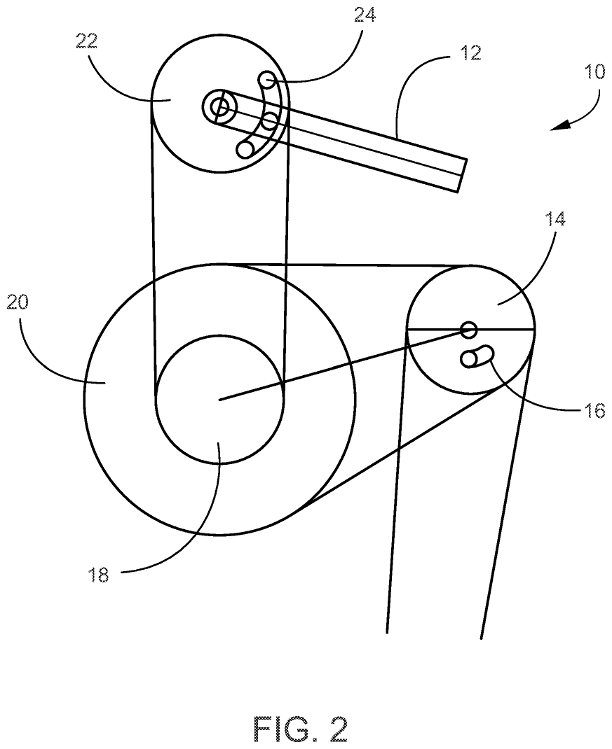

Referring now to FIG. 2, a device 10 for assisting in shoulder range of motion is illustrated according to one embodiment of the present invention. It should be noted that as used herein, the device 10 for assisting in shoulder range of motion may be simply referred to as “the device”. Some embodiments of the invention provide a stabilizing structure such as a pad configured to inhibit motion of the scapula and, alternatively, to allow motion of the scapula in order to mirror natural bodily movement in a predetermined ratio of 2:1 gleno-humeral to scapular motion during abduction or flexion of the shoulder.

A force application mechanism (not shown in FIG. 2) is operatively coupled with an engagement mechanism for operatively coupling with the user's arm. The force application mechanism may be one or more of the following, for example: motor(s), linear actuator(s), rotary actuator(s), mechanical system(s) utilizing, for example, sprockets, or the like. As the force application mechanism provides rotational force in the counterclockwise direction of FIG. 2 about gear 14, a chain, belt, or other connector translates the rotational motion to gear 20, which is coaxial with smaller gear 18. As used herein, when rotary actuator is used, it could be replaced, in certain embodiments or applications, with a linear actuator and operatively coupled elongate member to provide similar rotational force as a rotary actuator. Gear 18 translates its rotational motion via chain, belt or other connector to gear 22. Gear 22 is operatively coupled to the pad 12 such that as gear 22 rotates, the pad 12 rotates concurrently. The size of gear 18 is selected intentionally in relation to the size of gear 20 in order to translate the rotational motion received from gear 14 in a substantially 2:1 ratio, thereby representing anatomically correct gleno-humeral to scapular motion.

Notably, as the force application mechanism initially begins placing force on a user's arm, the channel 16 allows gear 14 to rotate along with the abduction/flexion motion, which is motion synonymous with the first phase of movement wherein the scapula does not move. When gear 14 reaches the end of channel 16, so the gear 14 is no longer able to move along with the arm but rather begins rotating about its axis, thereby translating rotational motion to gear 20, which is synonymous with the second phase of movement. That motion is reduced as discussed herein and transferred from gear 18 to gear 22, which is operatively coupled with the pad 12 in order to force the pad 12 to a higher angle to the neckline of the user.

In accommodating different users, embodiments of the invention provide for variable distance between the gear(s) and/or sprocket(s) in order to account for different sized users.

In various embodiments of the invention, controlling scapular motion, that is, restricting scapular motion and allowing scapular motion in an anatomically correct way during shoulder flexion and/or abduction, which is accomplished by the pad 12 in the embodiment of FIG. 2, may be accomplished by utilizing a number of different structures. Some example embodiments for selectively controlling scapular motion are: using gear(s), chain and sprocket(s), friction wheel(s), rope and pulley(s), belt(s) and pulley(s), block and tackle mechanism(s), linkage(s)/bar(s)/arm(s), electric motor(s), servo-controlled or mechanically controlled linear and rotary actuator(s), and/or cam(s).

In alternative embodiments, the 2:1 gleno-humeral to scapular ratio is maintained throughout the system's entire range of motion, rather than accommodating two differing phases of motion as discussed above. As discussed above, some embodiments utilize two phases of motion: the first enabling only gleno-humeral motion until a certain point of motion at which point the system is configured to enable a certain ratio of gleno-humeral to scapular motion, such as a 2:1 ratio, thereby allowing the scapula to move. In yet another alternative embodiment, the system restricts scapular motion for a phase of motion, and once the arm reaches a predetermined threshold of motion, the system allows both gleno-humeral and scapular motion in the normal range of motion, that is, in an unrestrained manner.

In some embodiments, a restraining strap limits motion of the scapula with a dynamic (or variable) tightness or dynamic line of action (similar to the insertion point of a muscle). For example, one embodiment of such a mechanism is configured by attaching a strap to a gear or sprocket (e.g., gear 22).

Various embodiments of the invention are shown in the several figures and include several primary concepts. Embodiments of the invention are typically attachable and detachable from a folding chair and operate via a manual pumping mechanism leveraging hydraulic fluid force application to rotary drives.

Embodiments of the device provide the ability to stretch in four (4) different planes of motion including (i) abduction (both bent-arm and straight-arm), (ii)) forward flexion, (iii) external rotation, and (iv) internal rotation.

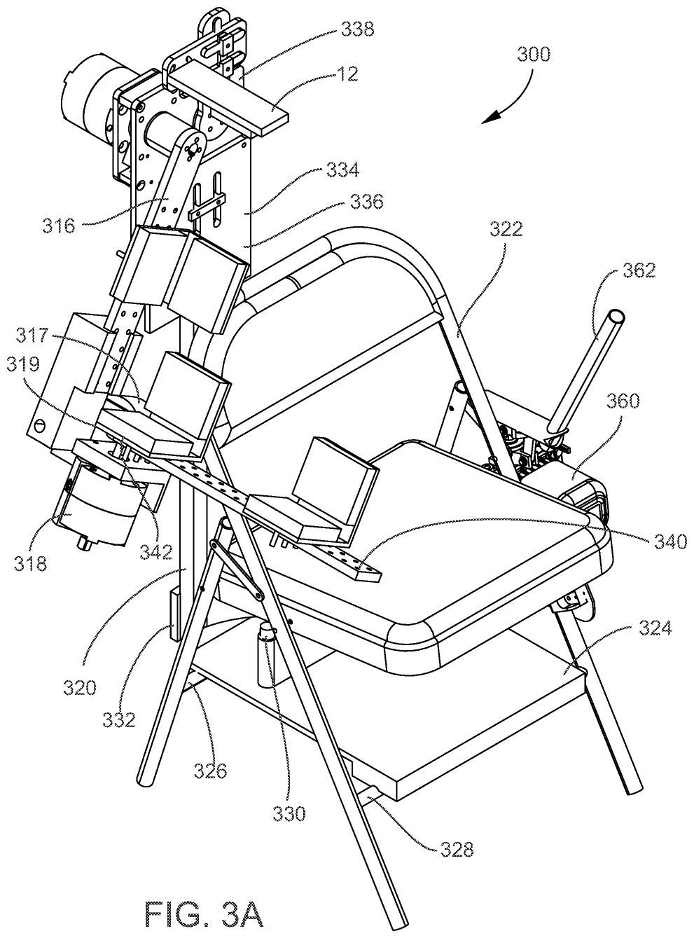

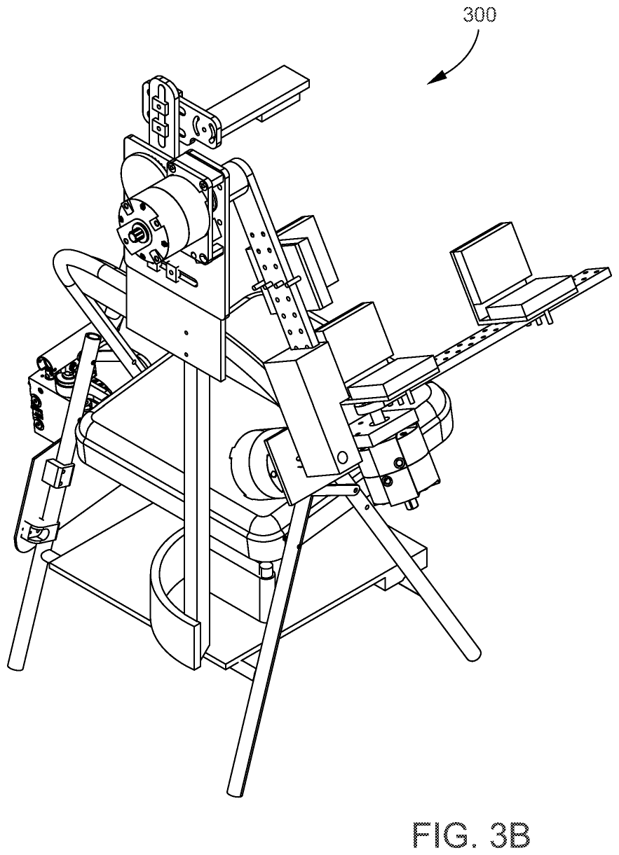

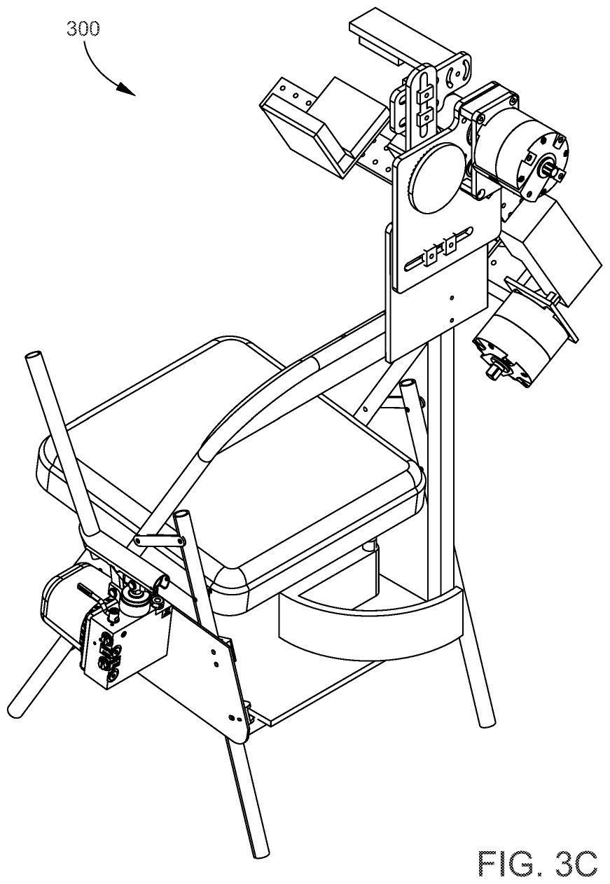

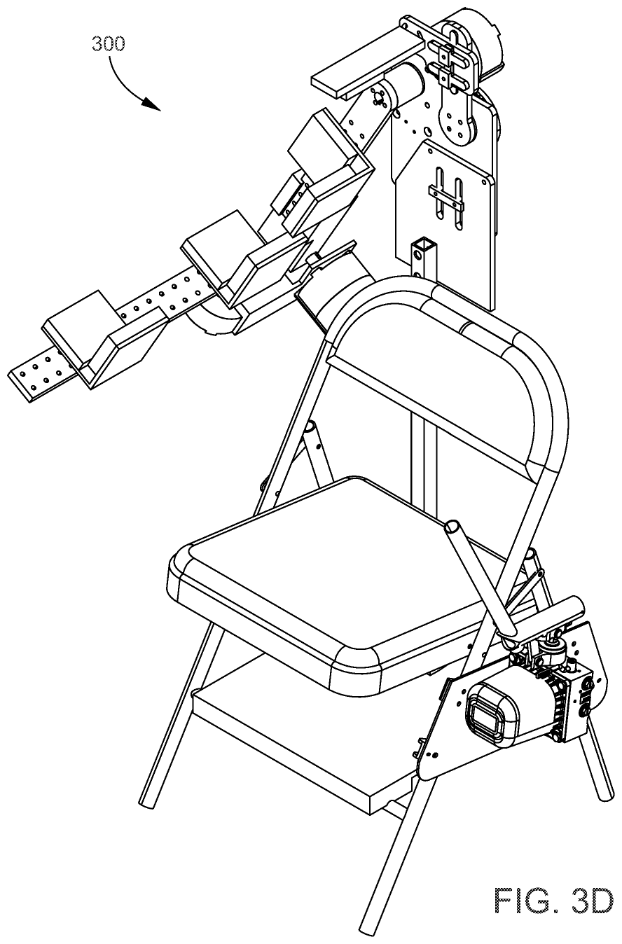

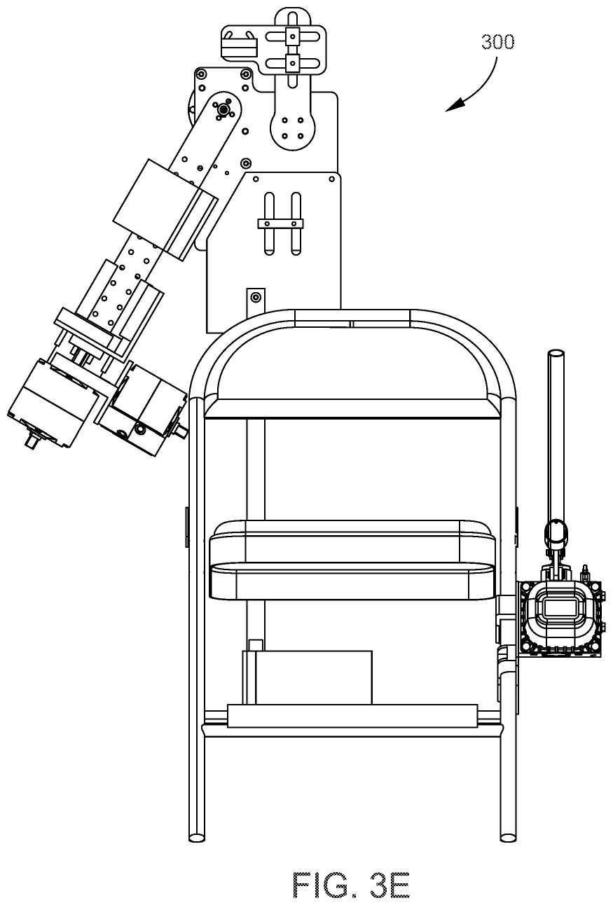

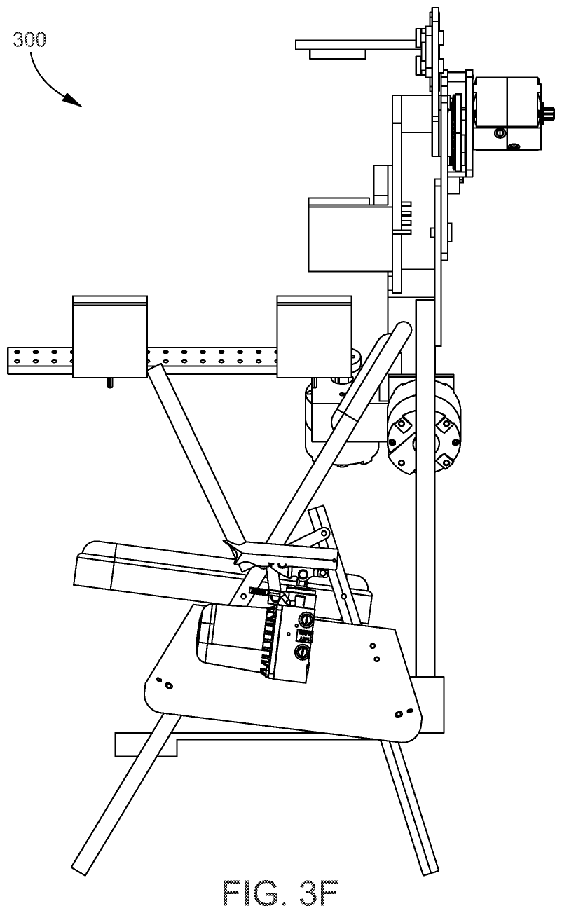

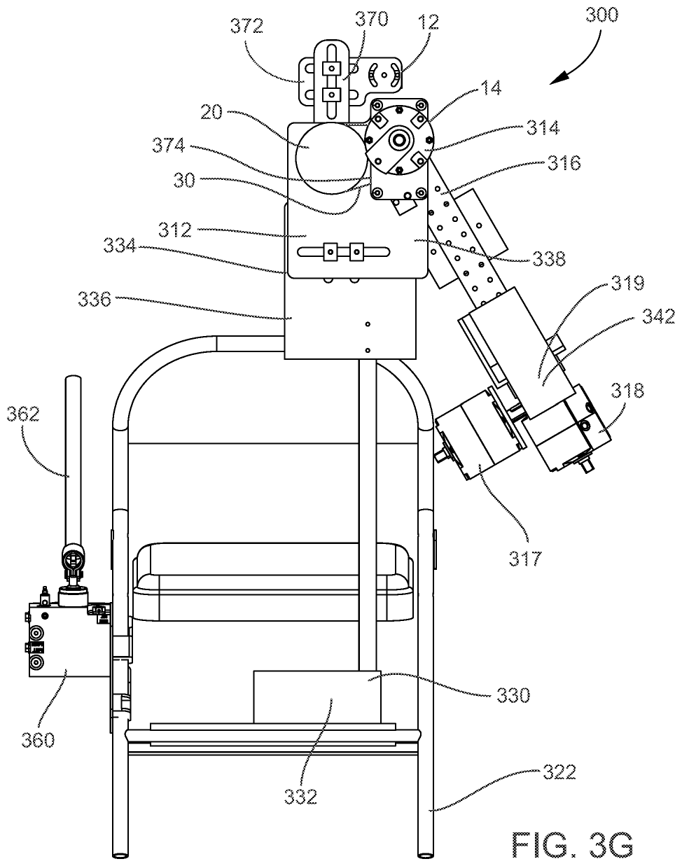

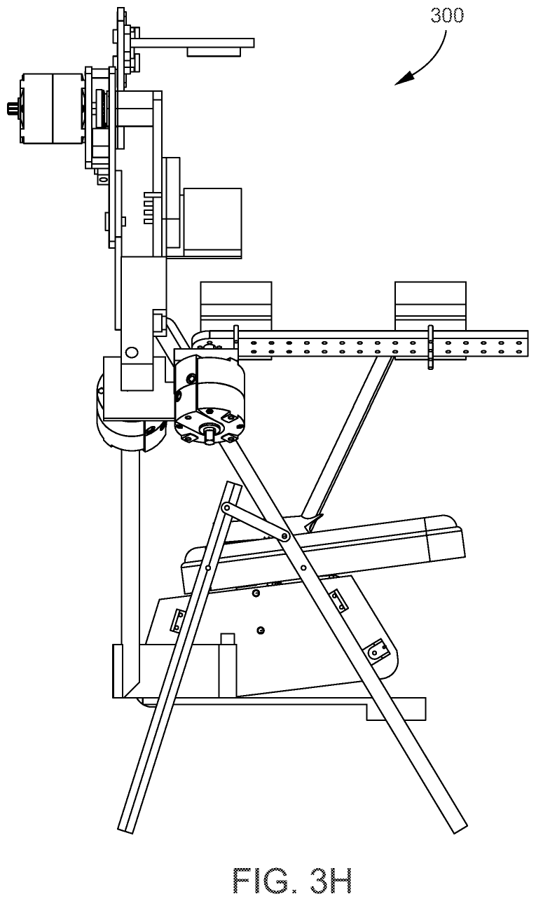

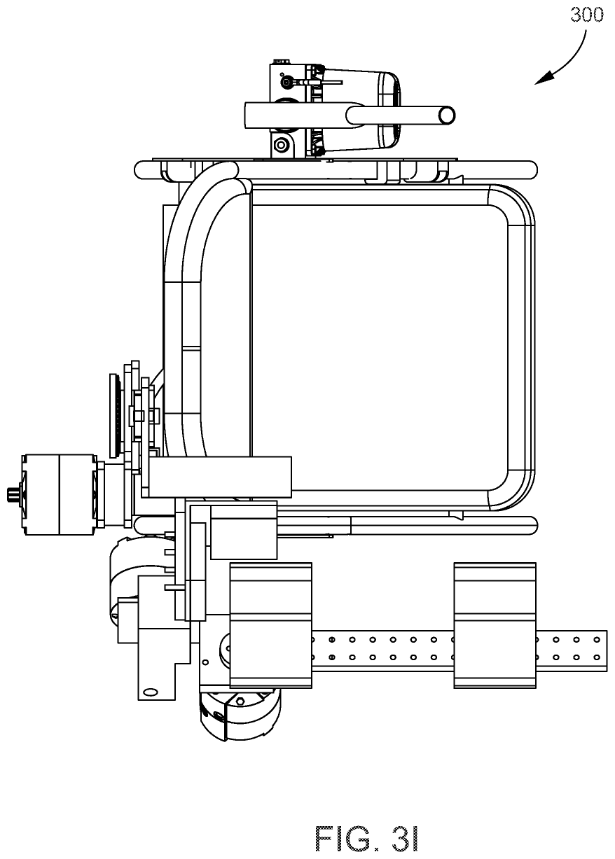

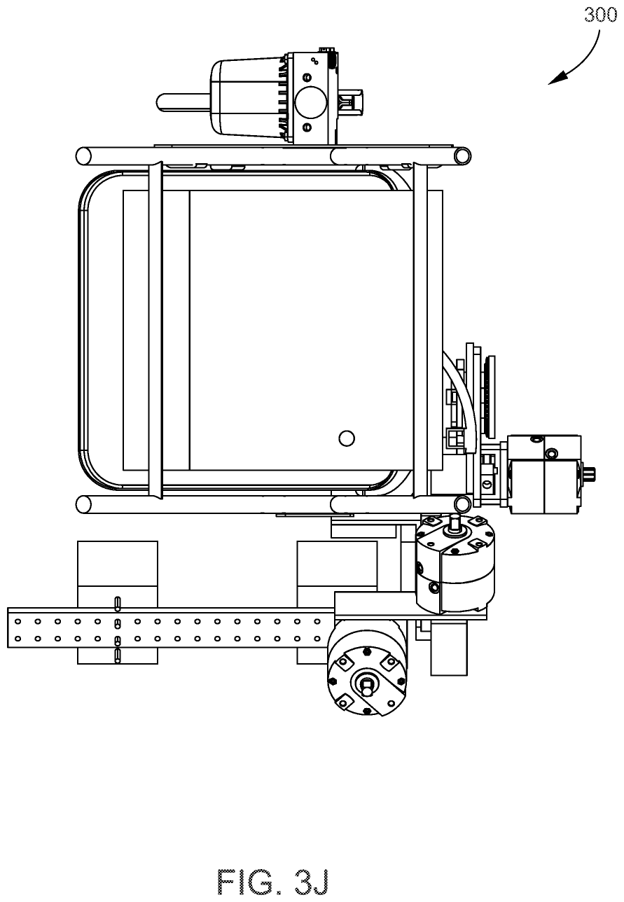

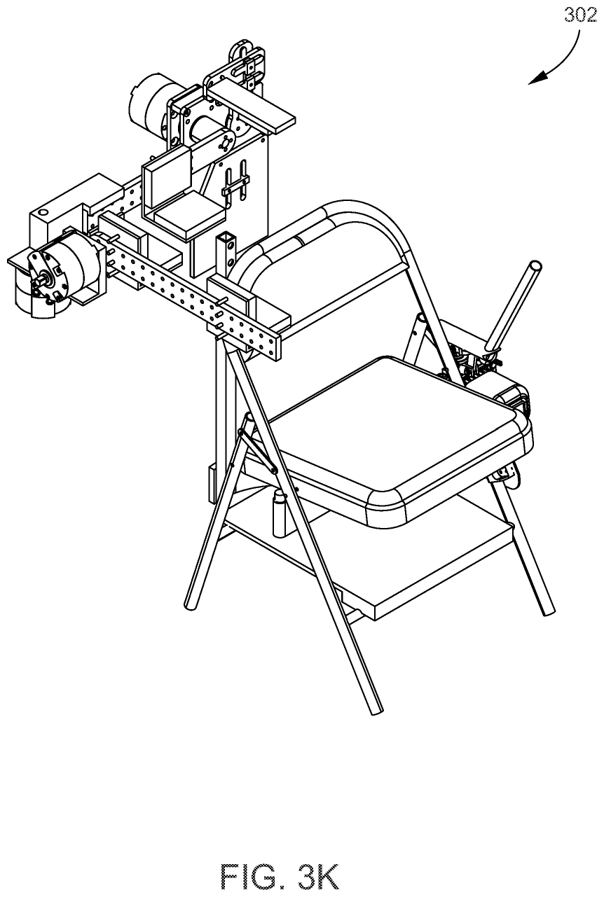

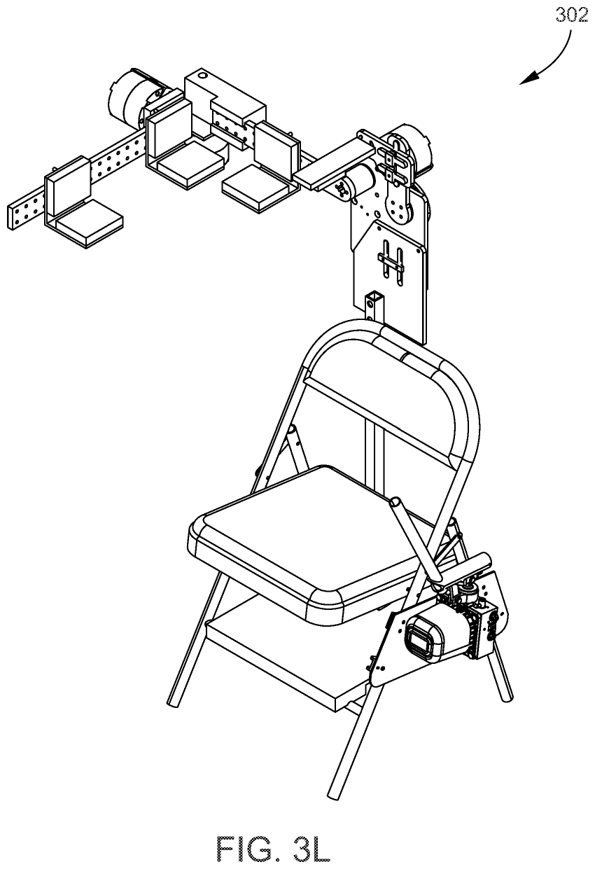

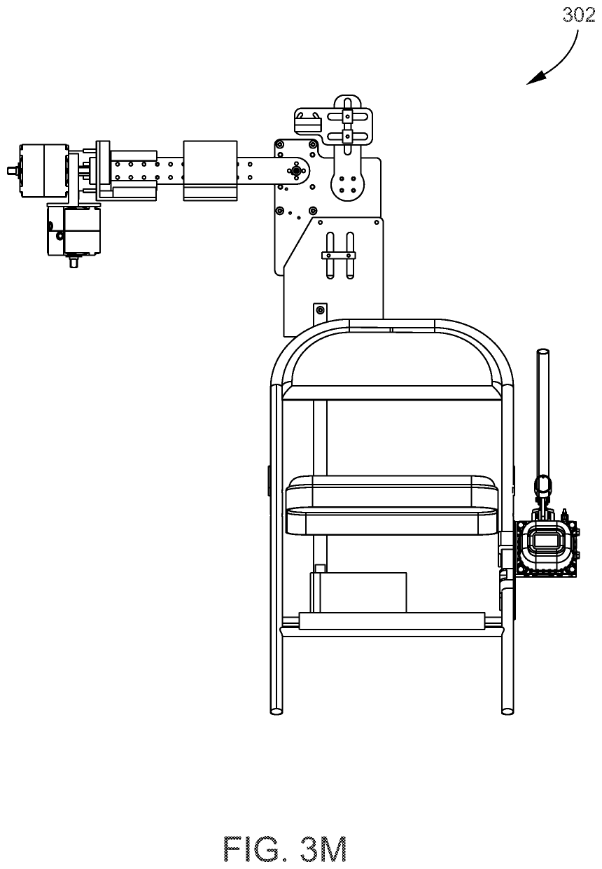

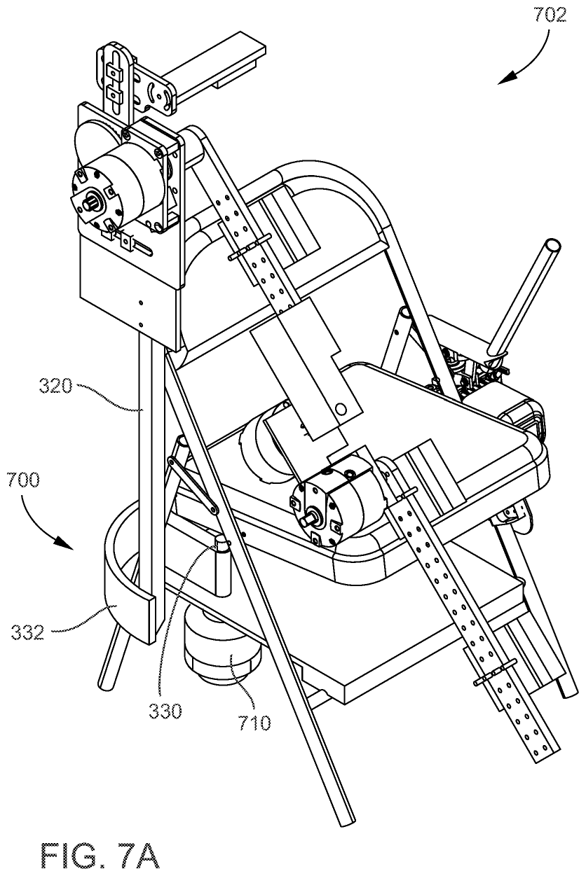

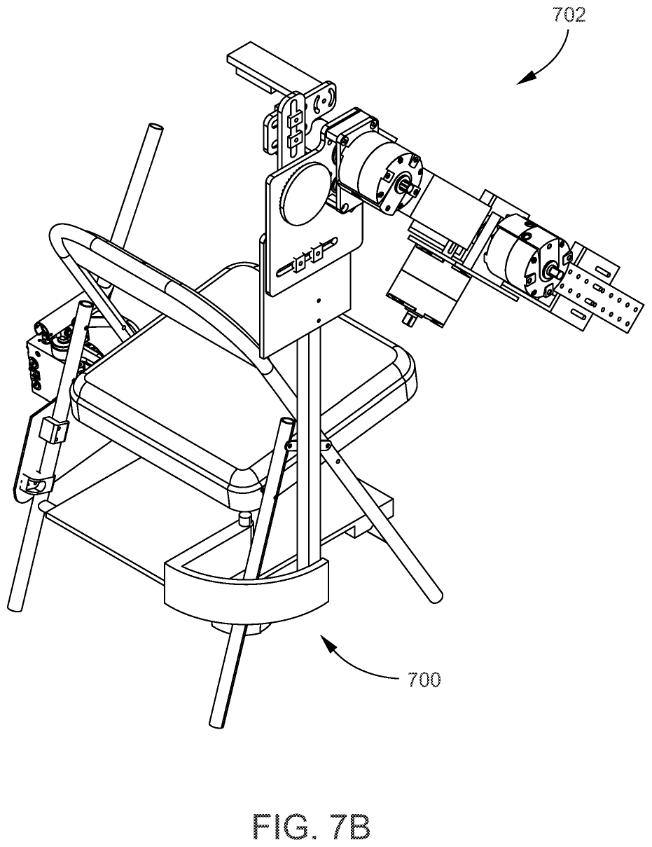

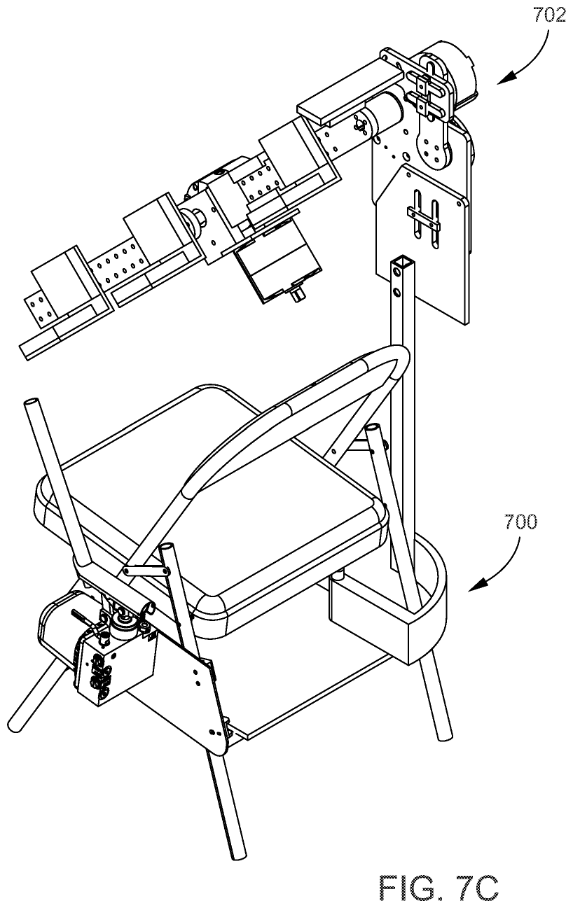

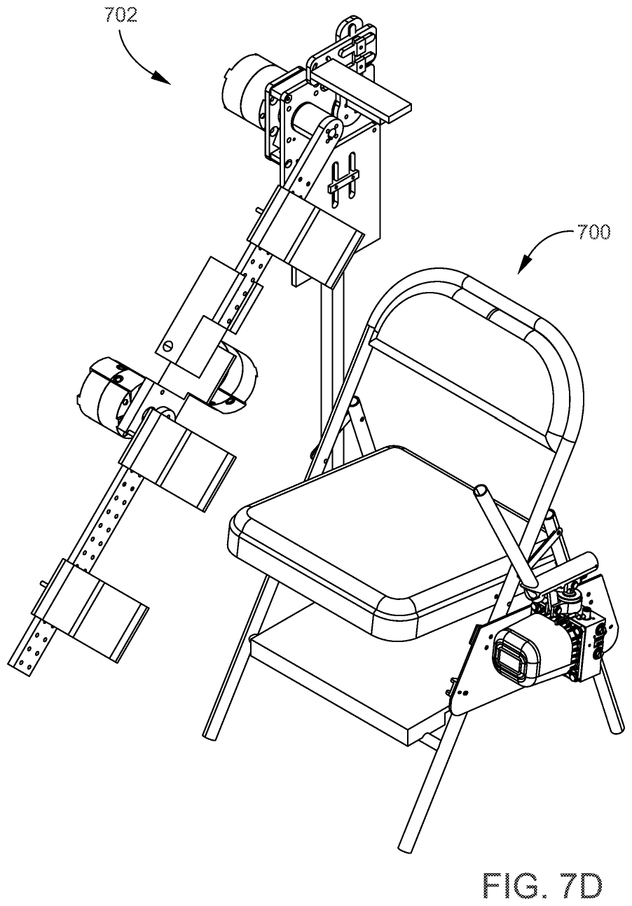

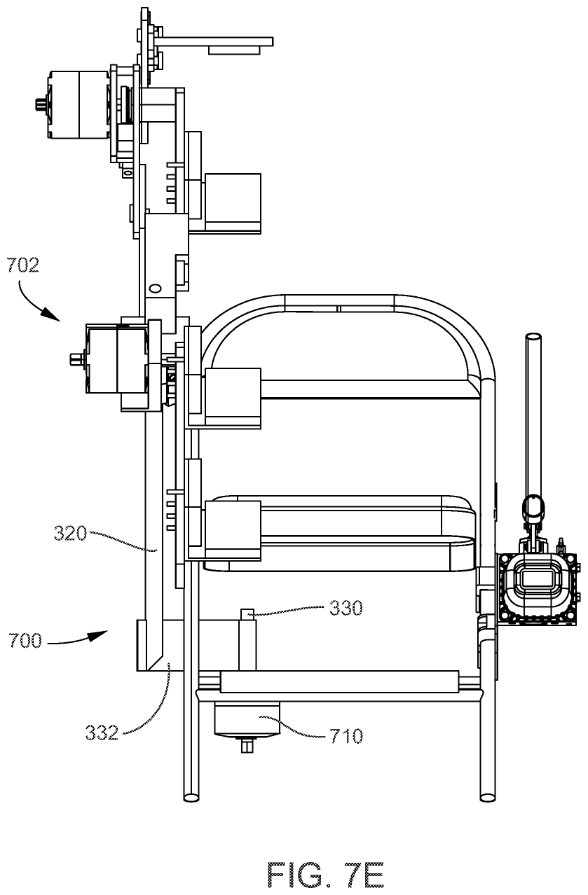

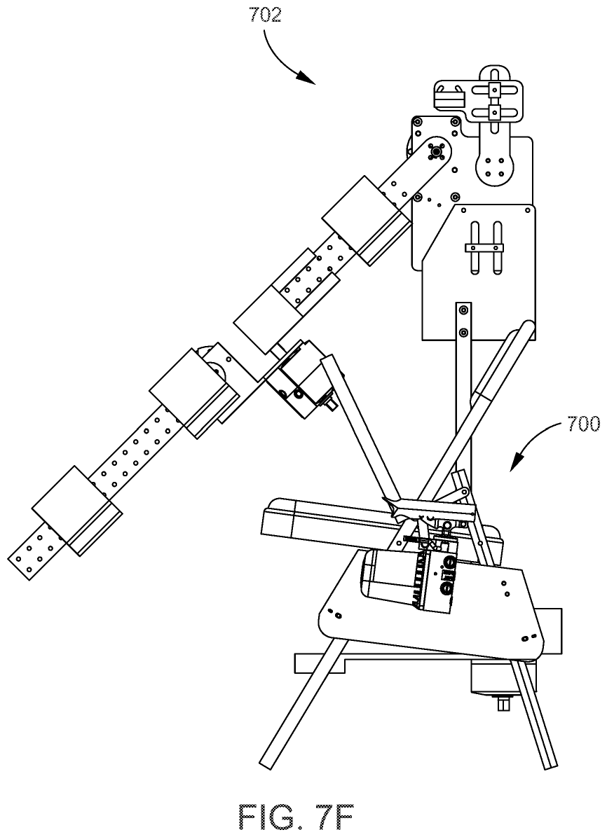

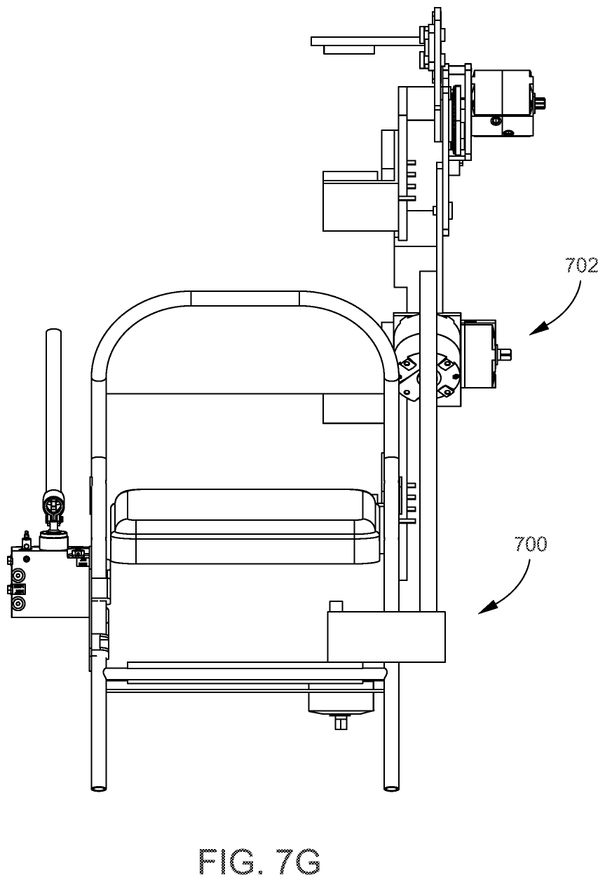

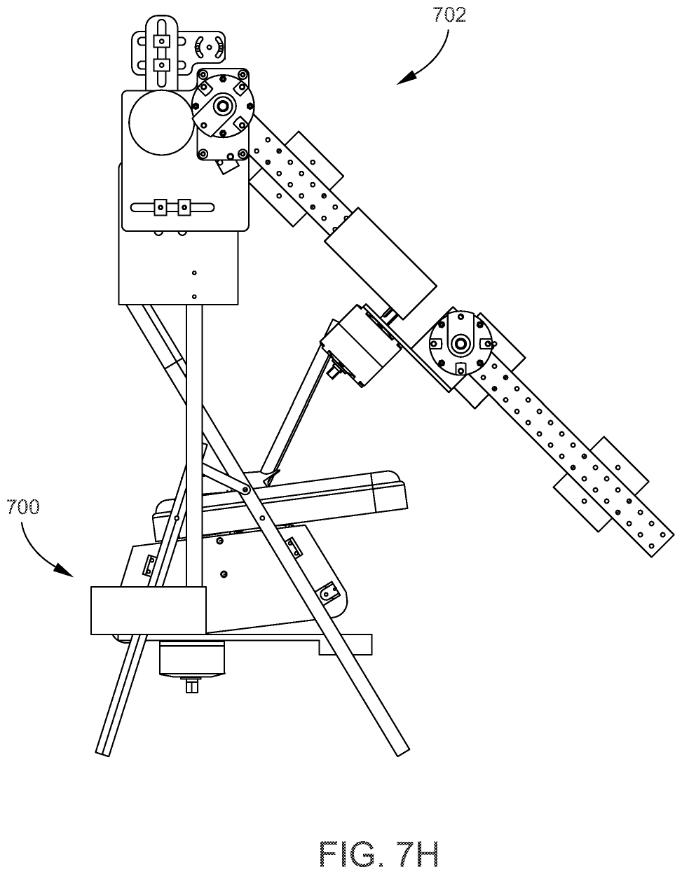

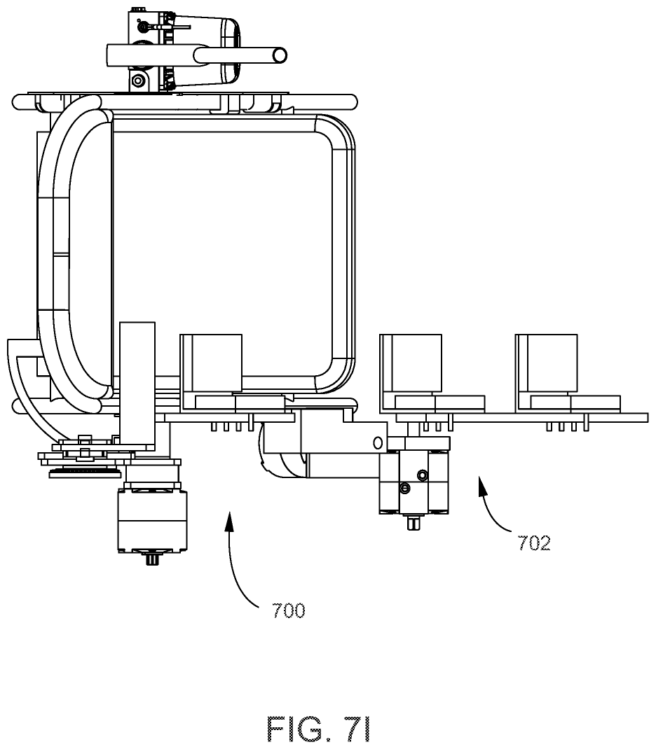

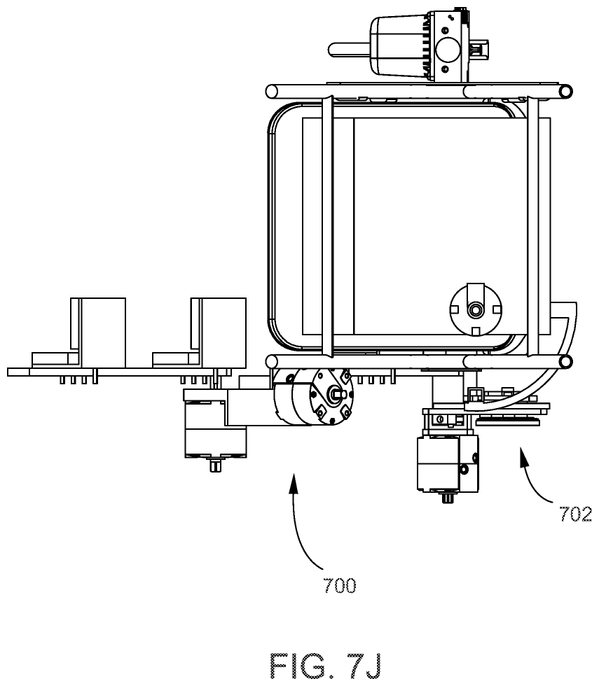

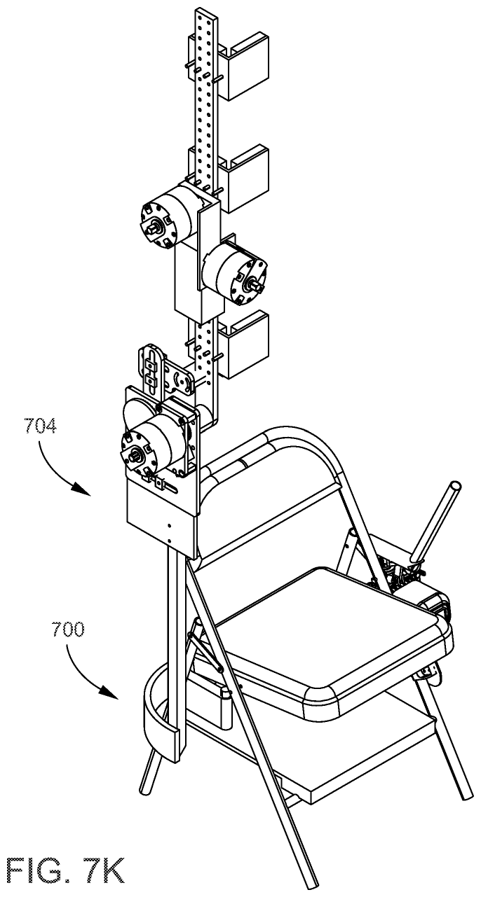

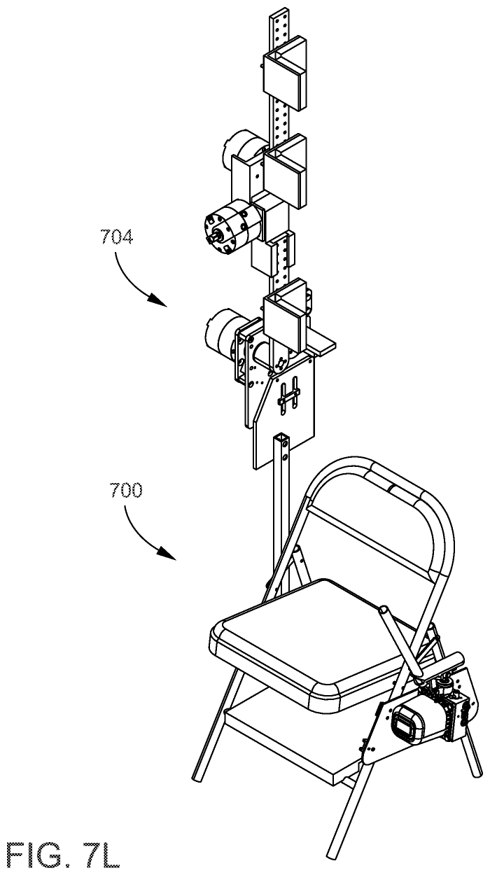

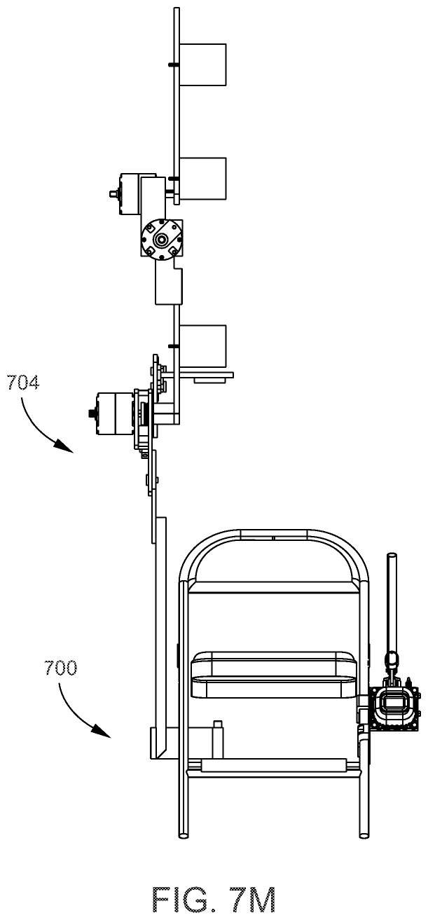

Embodiments of the device are reconfigurable into two different structure positions: one where the upright is positioned at the rear of the chair and the primary rotary drive is positioned for applying force to assist with abduction (see FIG. 3, for example), and the second where the upright is positioned at the side of the chair and the primary rotary drive is positioned for applying force to assist with forward flexion (see FIG. 7, for example). The system may be modular or swivel-enabled, but in either case the upright is rotated ninety (90) degrees about its longitudinal axis when shifting from the first position to the second position. The modular configuration is enabled by slots in the chair plate. One slot receives the upright in the rear of the chair such that the device is configured for abduction and another slot receives the upright at the side of the chair such that the device is configured for forward flexion. In a swivel-enabled configuration, a hinge may be operatively coupled to the upright so that the upright may be rotated from the rear to the side of the chair.

Modular or swivel-enabled configurations may be adjusted by a patient without the need for a technician to perform an in-home service. This is because the transition between positions may involve a spring loaded pin and hole system where the support is hinged to swing the device from behind the chair to the side of the chair.

Another primary concept of the device is the opportunity to perform a staged or ratio-based stretch. This is related to the discussion above with regard to FIG. 2, although in some embodiments, such as the embodiments shown in many of the figures, gears 18 and 22 are not used. Staged stretching utilizing embodiments of the device discussed herein includes two phases. Phase One (1) is an isolated gleno-humeral motion where the device inhibits motion of the scapula. This motion is for thirty (30) to sixty (60) degrees of isolated gleno-humeral stretch as discussed in medical literature. Phase Two (2) is where the device allows the scapula to move by allowing the shoulder pad 12 of the device 300 to move (with reference to FIG. 3A). A mechanism similar to the mechanism discussed with reference to FIG. 2 is included in the various embodiments discussed below, for example the embodiment of FIG. 3.

Shown in FIG. 3G is a rear view of the device 300 showing the plate 312 proximate to which the gears 20 and 14 operate similar to the device described with reference to FIG. 2 above. As rotary actuator 314 drives abduction of the device 300 by movement of upper arm 316, gear 14 (hidden) works in conjunction with gear 20 to provide the ratio stretch described herein. Link 370 is operatively coupled with link 372 which is operatively coupled with the shoulder pad 12 such that Phase One and Phase Two of the staged and ratio-based stretch is achieved. In some embodiments a tensioner 374 is in line with the chain 30 stretched around gear 20 and gear 14 so that the chain 30 remains in tension.

As the force application mechanism provides rotational force in the counterclockwise direction of FIG. 2 about gear 14, a chain, belt, or other connector translates the rotational motion to gear 20. Gear 20 translates its rotational motion through a hole in plate 338 to link 370 which is operatively coupled to link 372. Link 372 is operatively coupled to pad 12. As gear 20 rotates, links 370, 372 and pad 12 rotate concurrently. The axis of rotation of gear 14 is substantially aligned with the axis of rotation of the gleno-humeral joint during the abduction motion. Pad 12 that controls the motion of the scapula rotates around the axis of rotation of gear 20 which is substantially aligned with the axis of rotation of the scapula.

In the case of an exclusively ratio-based stretch, the ratio for the ratio stretching should be consistent for the whole range of the stretch, or in some cases, the ratio may be implemented after Phase One of isolated gleno-humeral joint stretching.

In the embodiment shown in the various figures, Phase One of the stretch is considered to end at thirty (30) degrees of abduction, where Phase Two begins. In some embodiments, the device is configured to provide forced stretch through both Phase One and Phase Two, and in other embodiments, the device is configured only to provide forced stretch through Phase Two. In certain embodiments, the extent of Phase One may be different than described above or may be modifiable, such as by modifying the length of channel 16 as shown in FIG. 2. A longer channel provides for a longer Phase One, which may go from zero to forty (40) degrees, for example. A shorter channel provides for a shorter Phase One, which may go from zero to twenty (20) degrees, for example.

In some embodiments, a single or multiple cam system may be utilized to achieve a desired staging/ratio. A cam may be engineered to adjust the ratio in larger abduction angles in order to keep the pad 12 in the correct anatomical position. In other embodiments, a plate may be disposed on the axis of the abduction rotary actuator 314 enabling adjustable control of the starting point when the scapular pad is allowed to move. Such position could be at the thirty (30)-sixty (60) degree abduction range as discussed above.

In some embodiments, adjustable distance between sprockets or cams may account for different sizes of people. Such adjustable distance may also allow for better tailoring of the stretch achieved by the device for a specific injury. Certain angles of stretch may work better depending on the nature of the scar tissue formation and the specific structures the scar tissue is attached to.

Sprockets (or gears), in various embodiments, may be made with variable teeth that enable the stretch to be varied at different points. That is, the shoulder pad 12 may be allowed to move less as the abduction angle increases closer to vertical. Such feature prevents too much motion of the shoulder pad toward the neck or middle of the back, and such variable gearing also helps to maintain chain tightness. In certain embodiments, the chain 30 (FIG. 2) may be covered for safety and aesthetics.

In some embodiments, one or more of the components of the device 300, such as upright 320 may be collapsible or foldable in order to allow for smaller footprint and ease of packing.

Referring specifically now to FIGS. 3A-3J, a device 300 for assisting with shoulder motion is shown in an arm-bent, thirty (30) degree abduction configuration 301. Such a configuration can, in some treatment regiments, serve as a starting position for abduction movement. FIGS. 3K-3M illustrate the device 300 in an arm-bent, ninety (90) degree abduction configuration 302. Such a configuration can, in some treatment regiments, serve as an ending position for abduction movement. The device, with particular reference to FIG. 3A and FIG. 3G, is removably attached to a folding chair 322 by platform 324, which rests on chair cross-bars 326 and 328. In some embodiments, the platform is removably secured to the cross-bars 326 and 328 by clamp(s), hook(s), or other mechanism. The platform 324 is connected with a hinge 330 about which the device may swivel to move from an abduction to a forward flexion configuration, such as that shown with reference to FIG. 7. The upright 320 extends from the hinge arm 332 upward behind the chair 322 in the abduction configuration of FIG. 3. The upright 320 is connected to a plate base 334 having a bottom plate 336 and a top plate 338, which are operatively coupled to allow for adjustment based on patient size and shape. Anchored to the top plate is the abduction rotary actuator 314, which when activated, causes abduction movement in the upper arm 316 of the device 300. The upper arm 316 is operatively coupled to the lower arm 340, such as by a hinge joint 319, which may be driven by elbow bend rotary actuator 317. Elbow bend rotary actuator 317 is an optional component because the patient may be able to provide their own elbow bend and/or the device may be configured such that a manual selection mechanism such as a spring pin and hole mechanism is used to reconfigure the device from bent arm to straight arm and vice versa.

The device 300 may also have internal/external rotation hinge joint 342 that may be driven by internal/external rotary actuator 318 to cause internal rotation or external rotation of the patient's shoulder.

As shown, the device 300 has an upper arm rest 350 and two lower arm rests 352 and 354. The number and size of the arm rests may vary, and the arm rests may be adjustable along the respective lengths of the upper arm 316 and the lower arm 340. In some embodiments, straps or other arm securing mechanisms may be used, but in the embodiment shown none are used. Due to the motions being driven by the device, in most or all configurations no securing mechanisms are necessary.

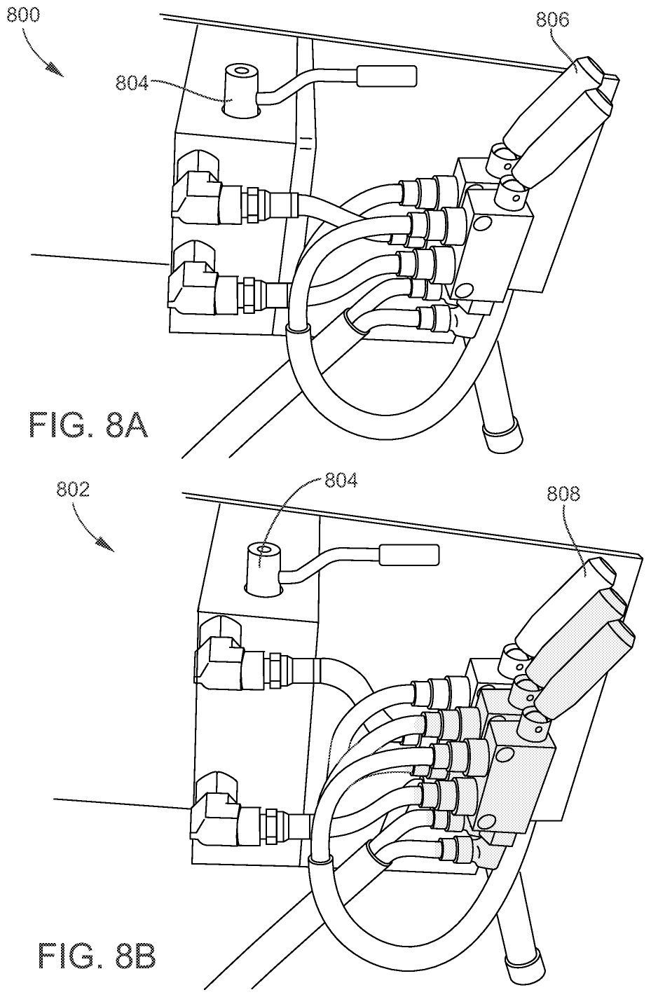

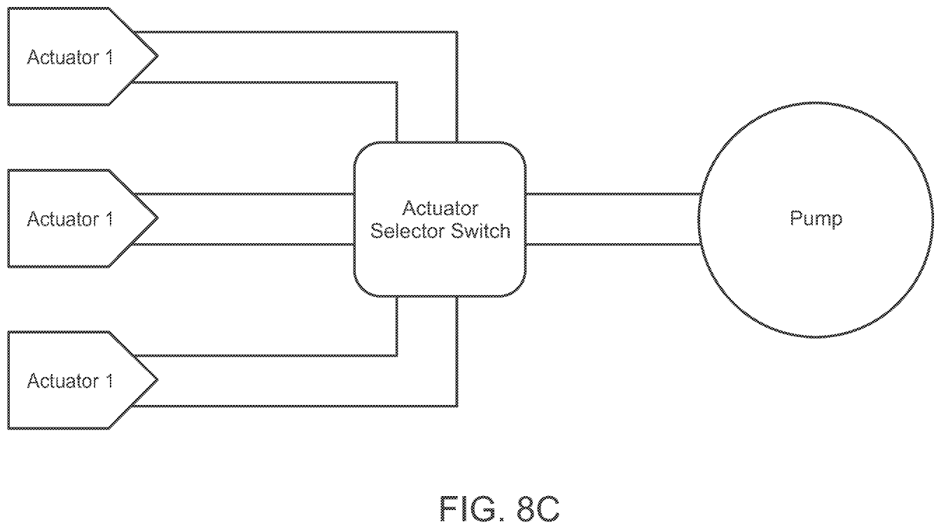

The various rotary actuators are driven by a hydraulic system and control mechanism further discussed with reference to FIG. 8 below. A pump 360 is driven by a pump handle 362, which when activated causes the pump to push or pull hydraulic fluid (or the like) through tubes connected to the engaged rotary actuator. The engaged rotary actuator transforms the hydraulic pressure into rotational force, which is applied to the corresponding device joint, thereby stretching the patient in the desired fashion.

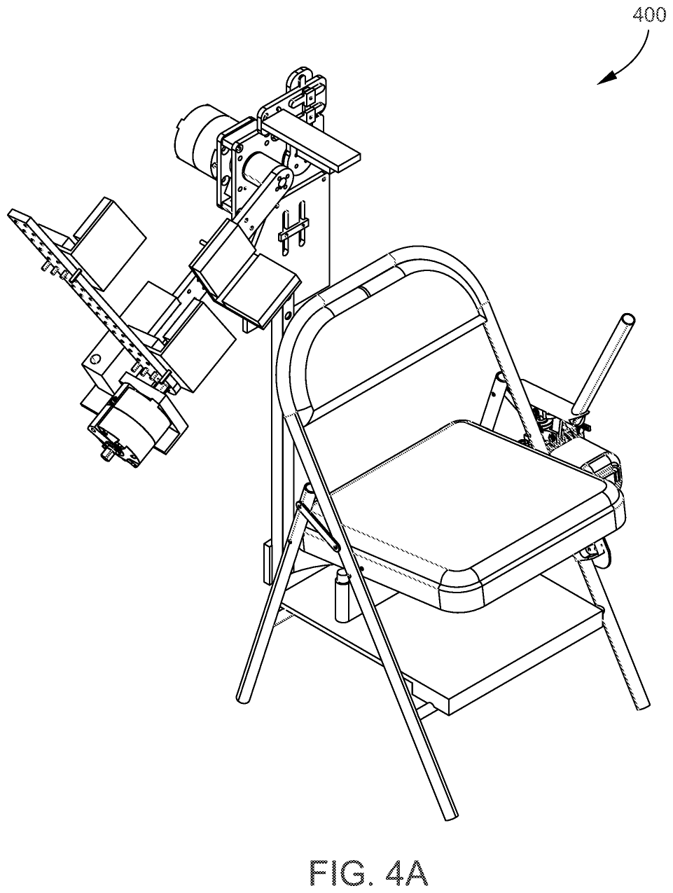

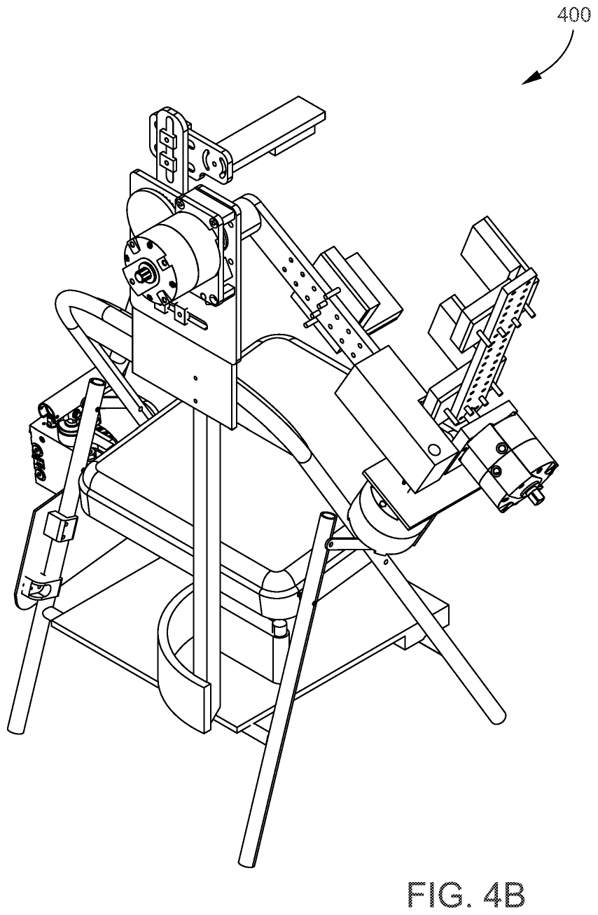

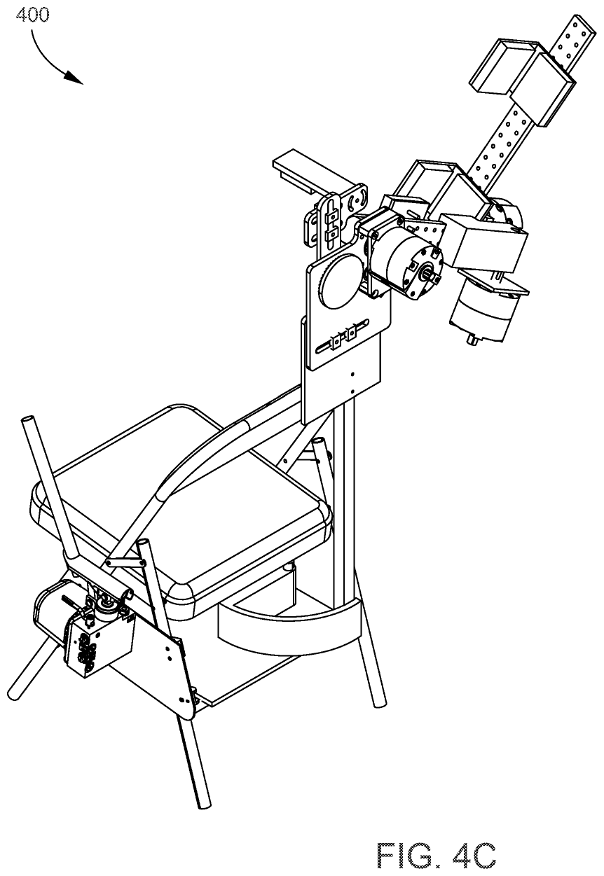

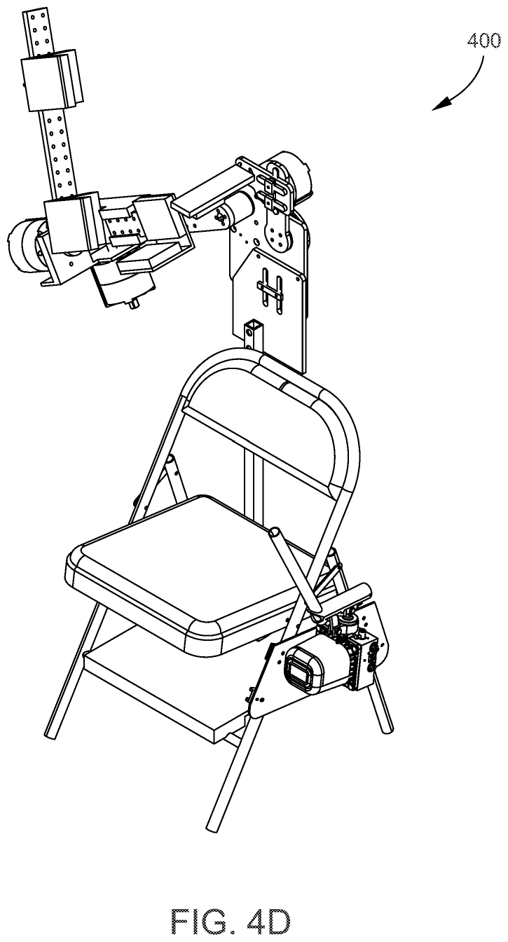

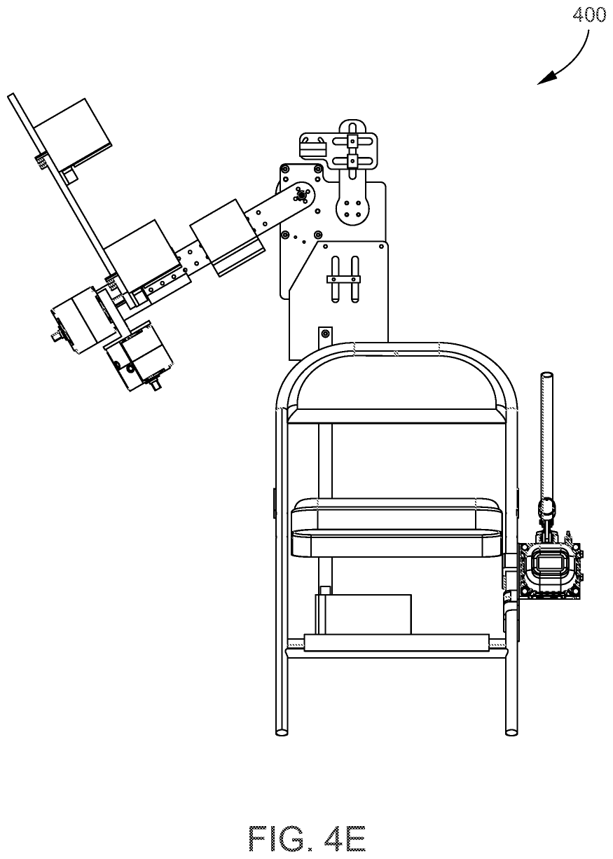

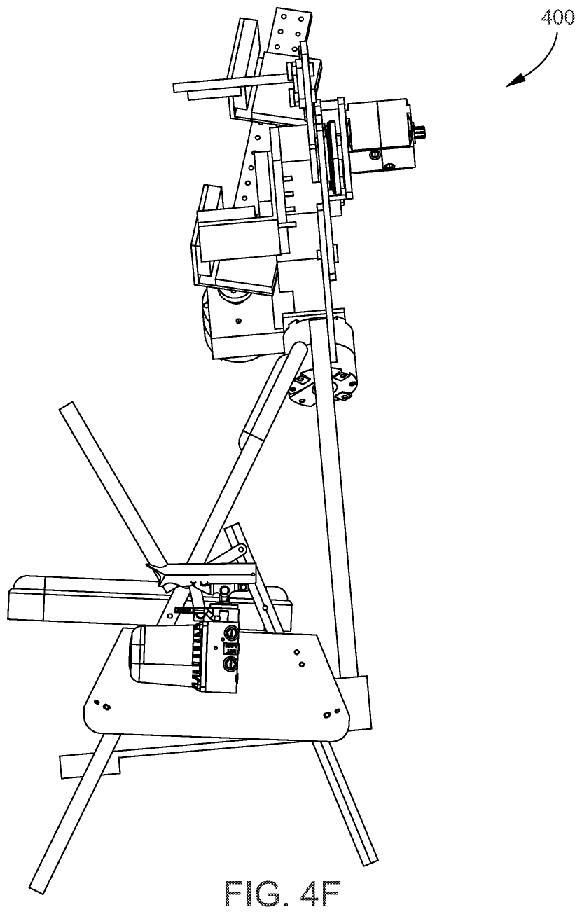

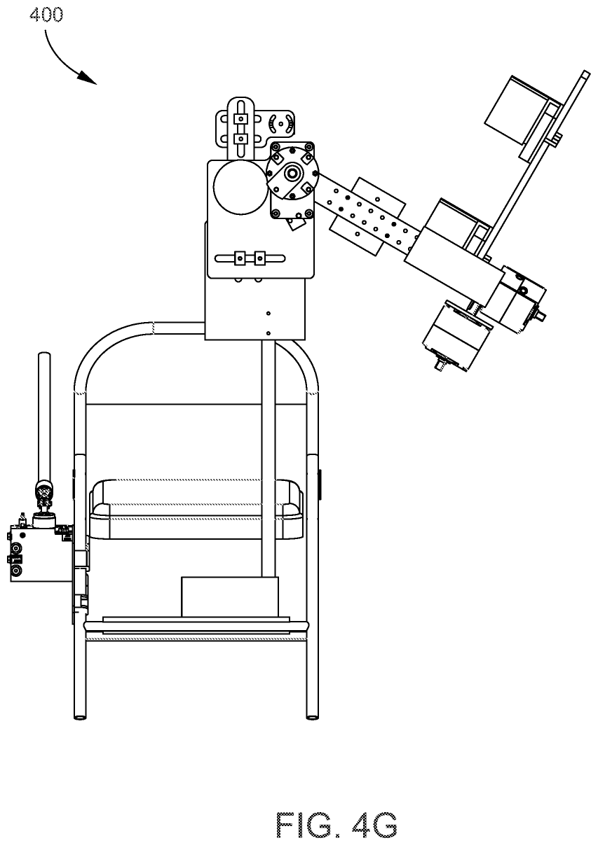

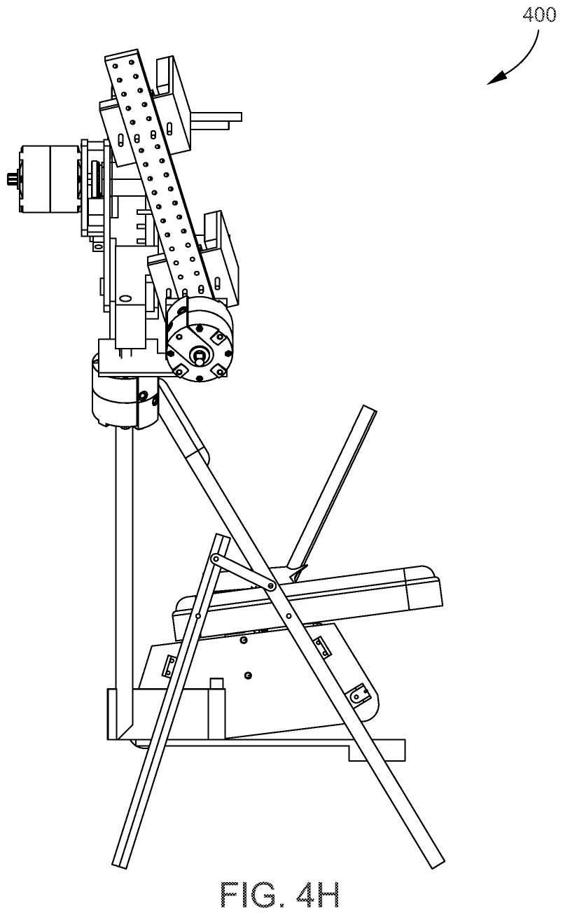

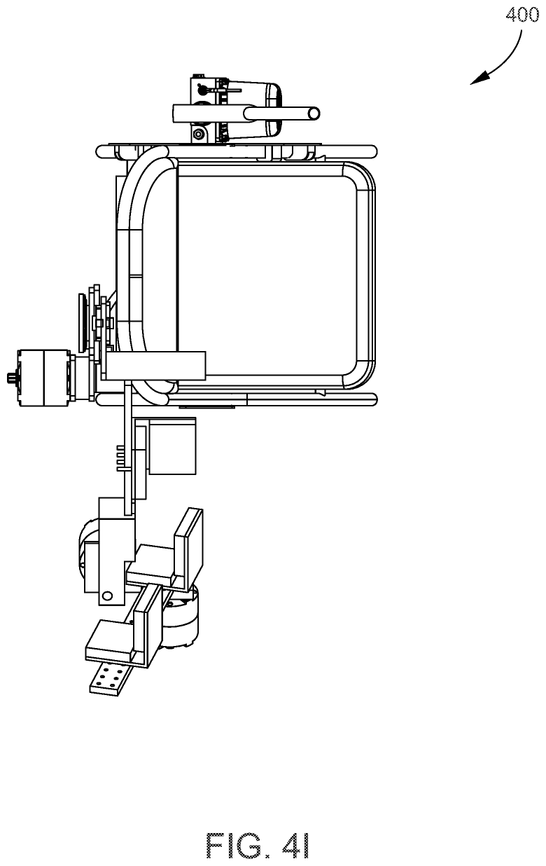

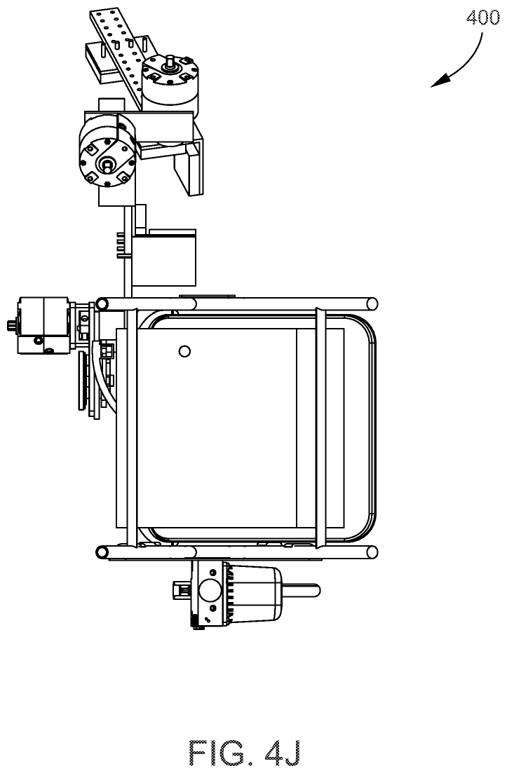

FIGS. 4A-4J illustrate the device 300 in an arm-bent, sixty (60) degree abduction, one-hundred five (105) degree external rotation configuration 400. The configuration shown in FIGS. 3A-3J can, in some treatment regiments, serve as a starting position for external rotation movement, and the configuration shown in FIGS. 4A-4J can, in some treatment regiments, serve as a starting position for external rotation movement.

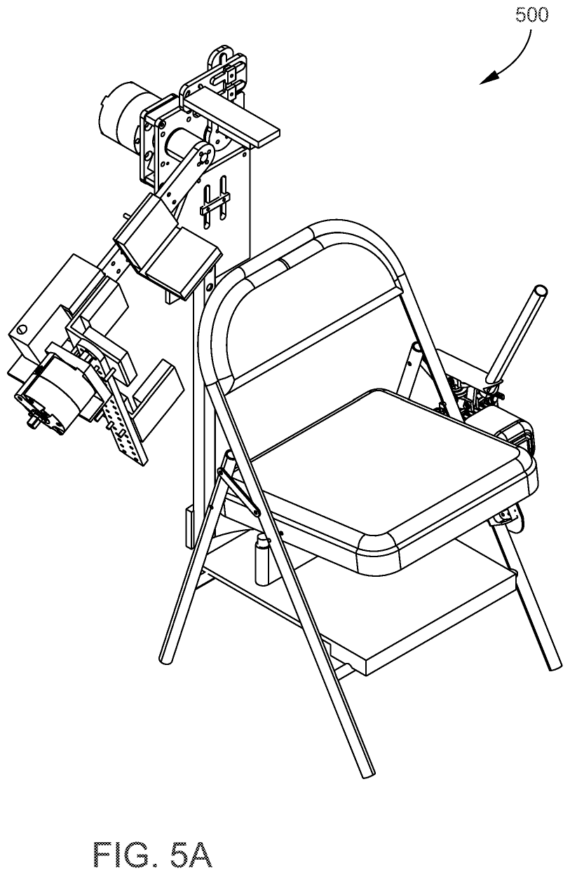

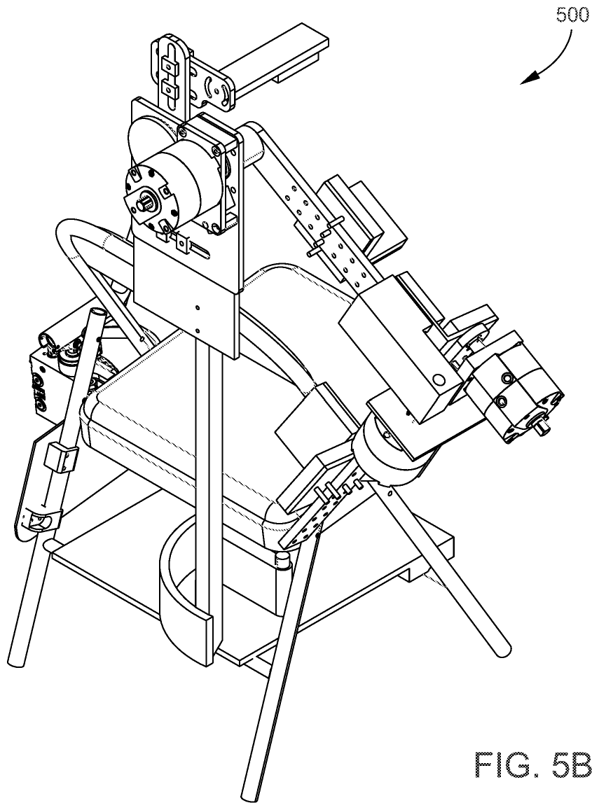

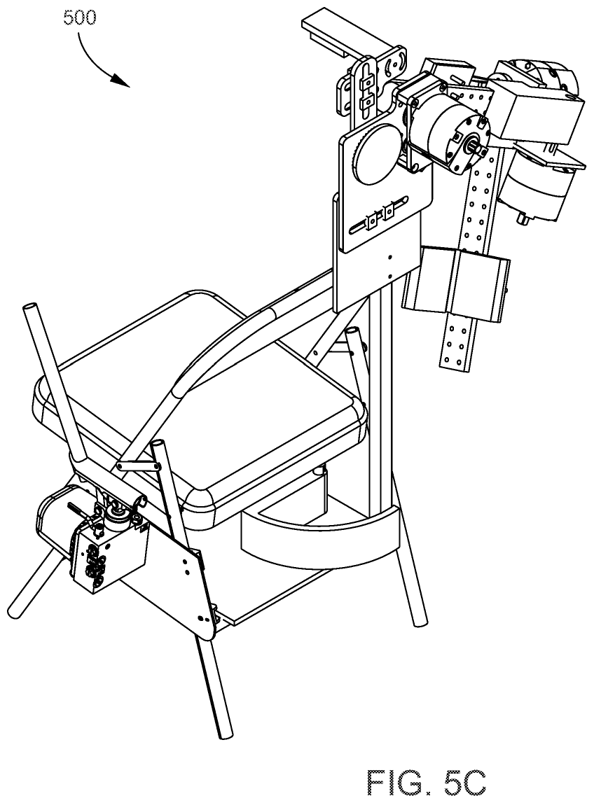

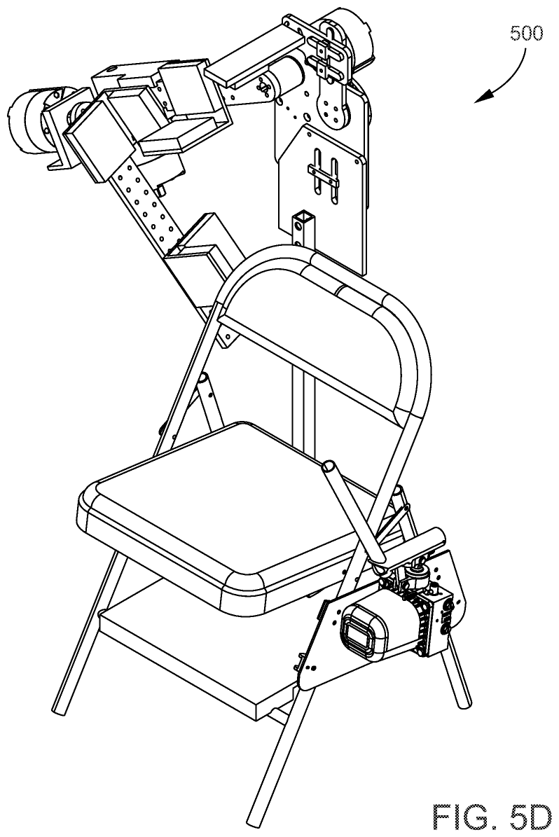

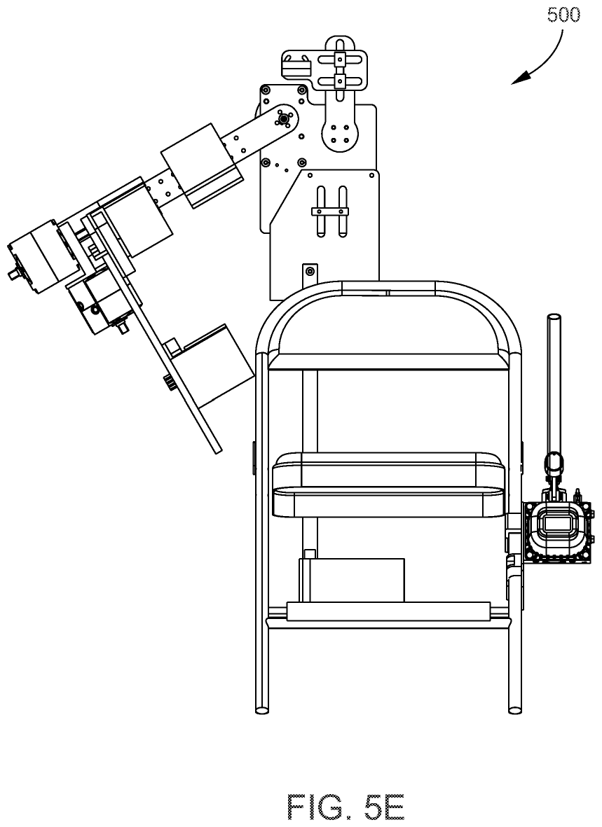

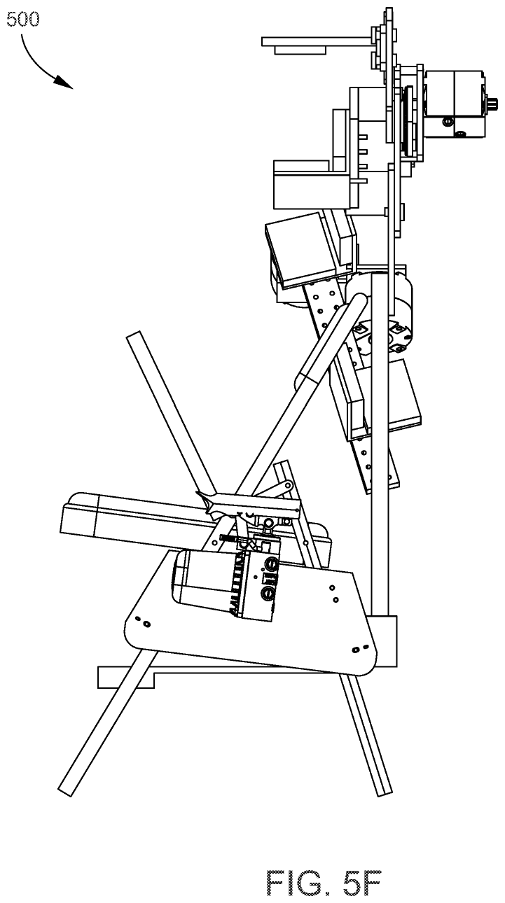

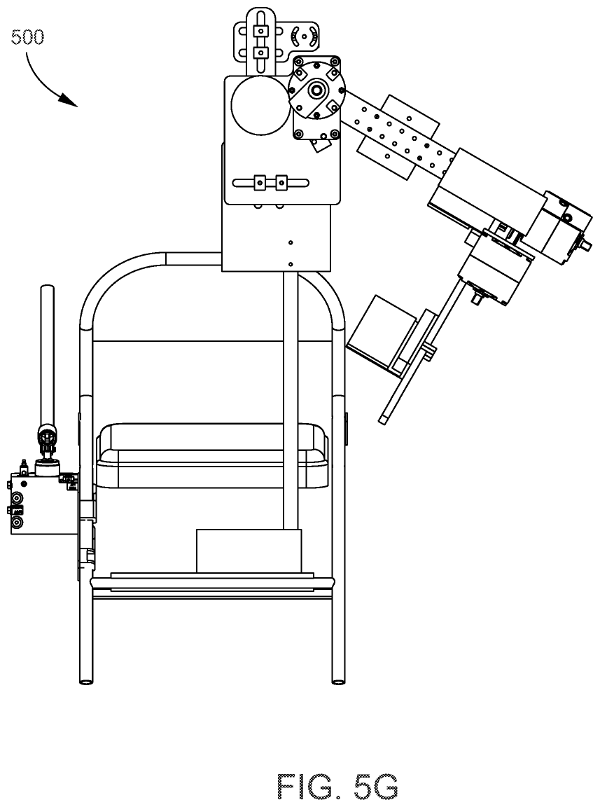

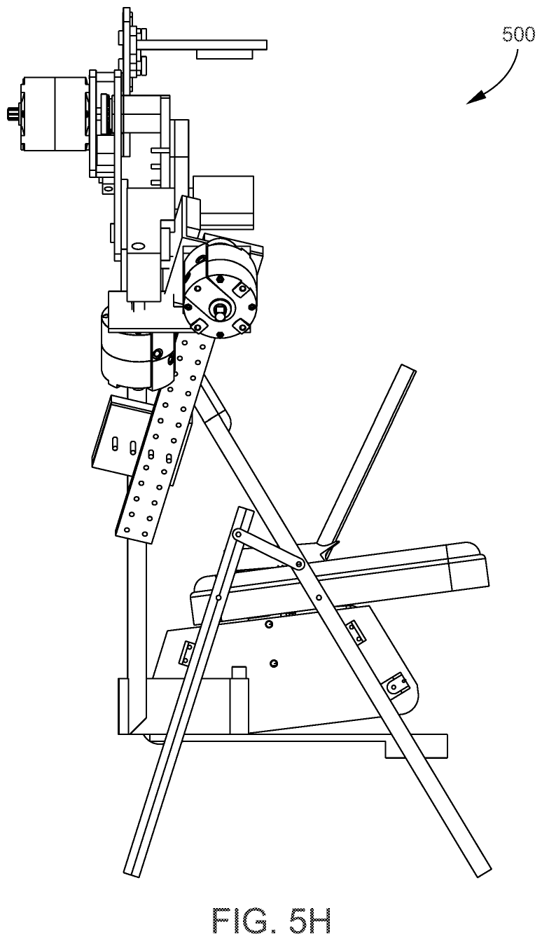

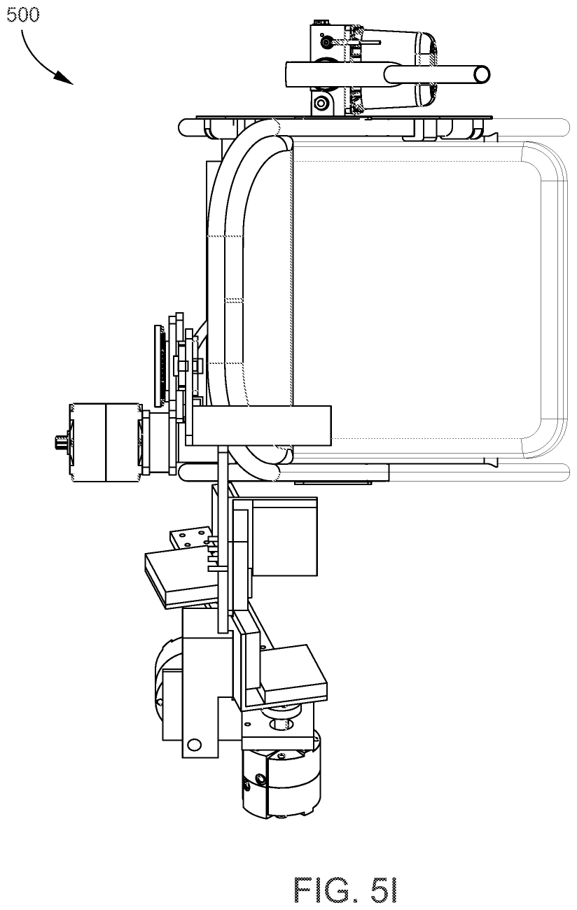

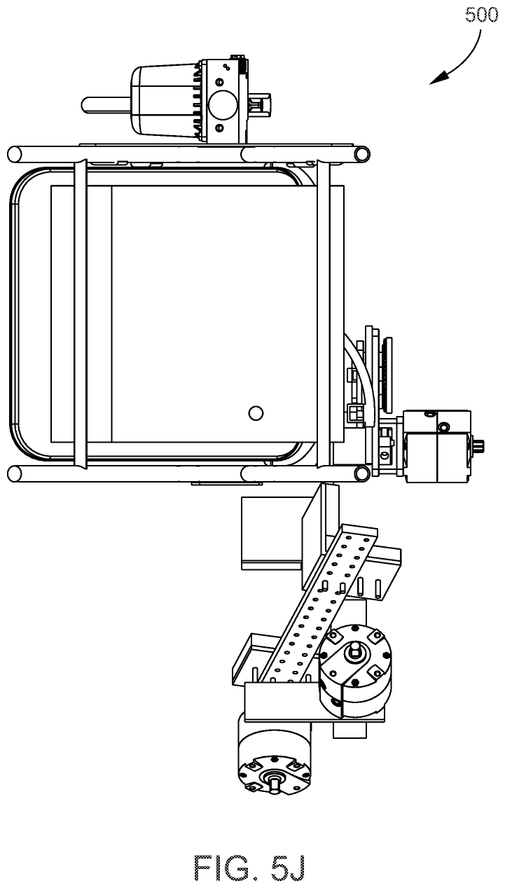

FIGS. 5A-5J illustrate the device 300 in an arm-bent, sixty (60) degree abduction, one hundred five (105) degree internal rotation configuration 500. The configuration shown in FIGS. 5A-5J can, in some treatment regiments, serve as an ending position for external rotation movement, and the configuration shown in FIGS. 3A-3J can, in some treatment regiments, serve as an ending position for external rotation movement.

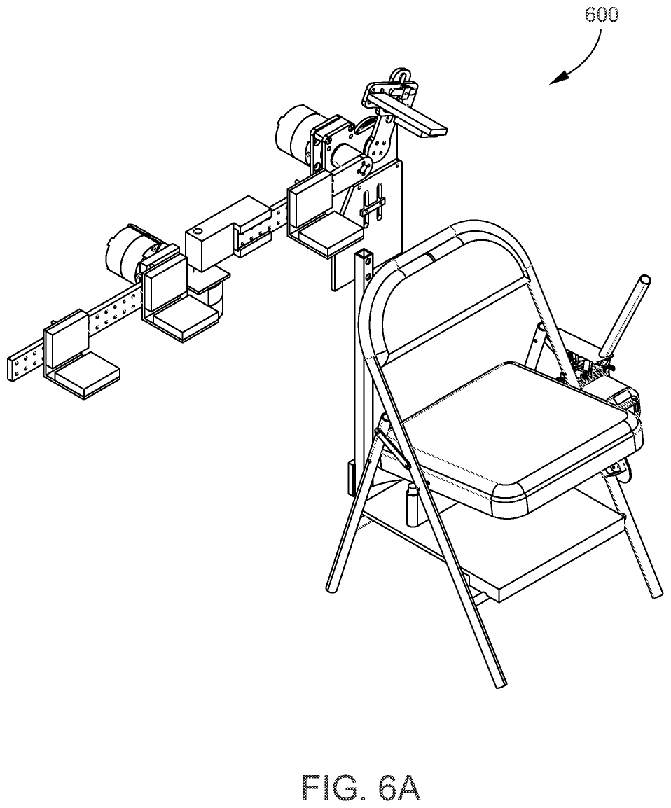

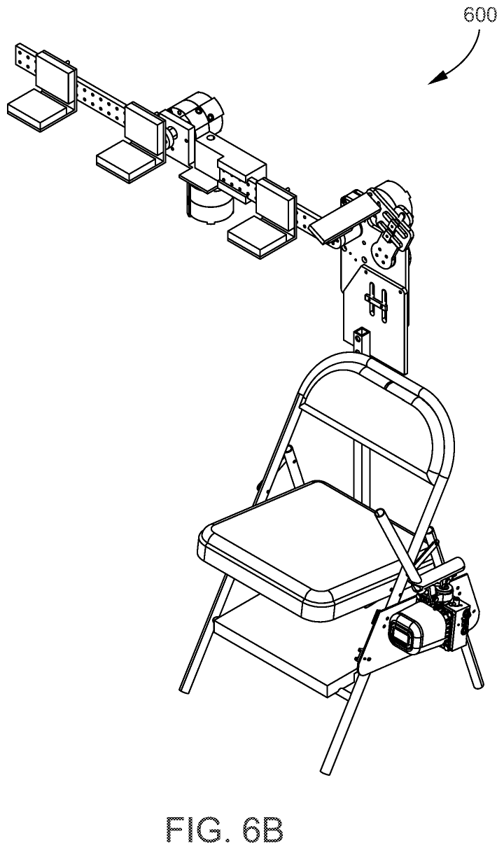

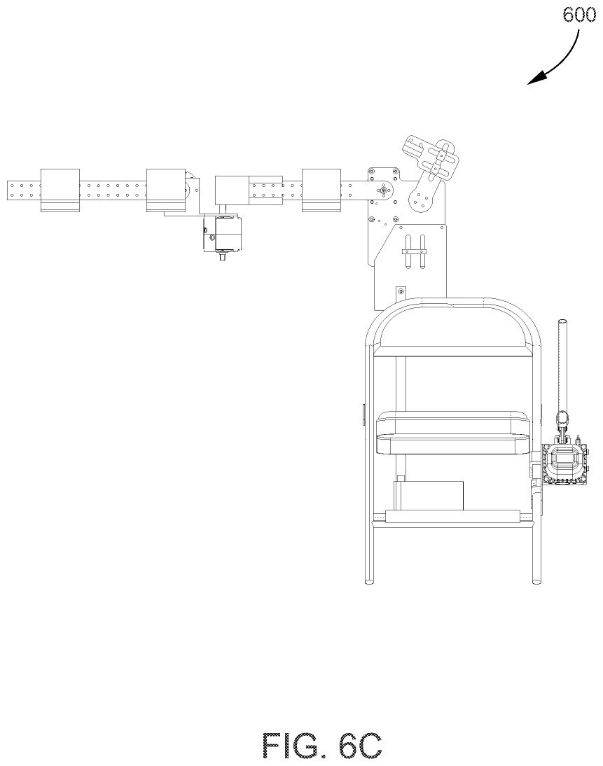

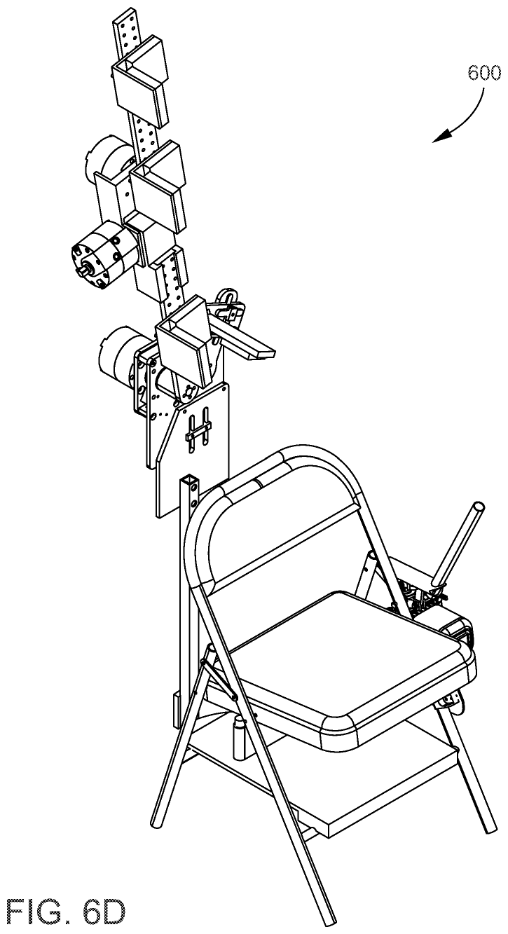

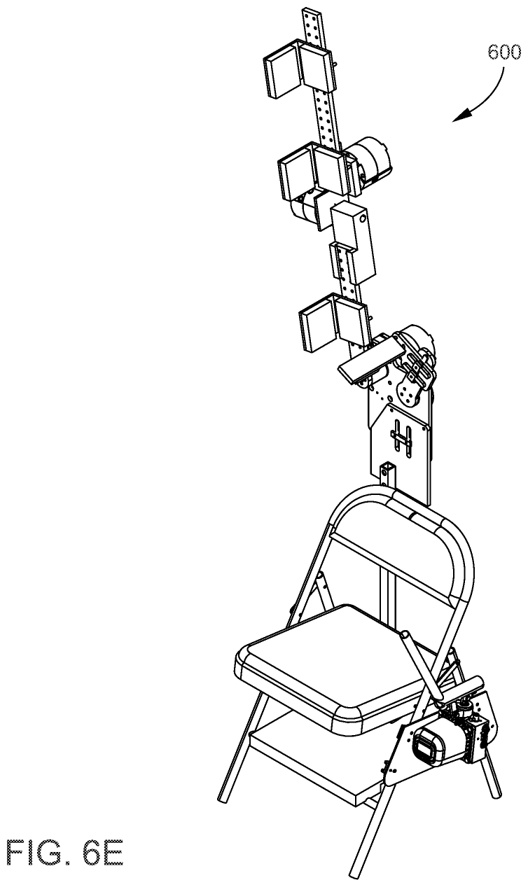

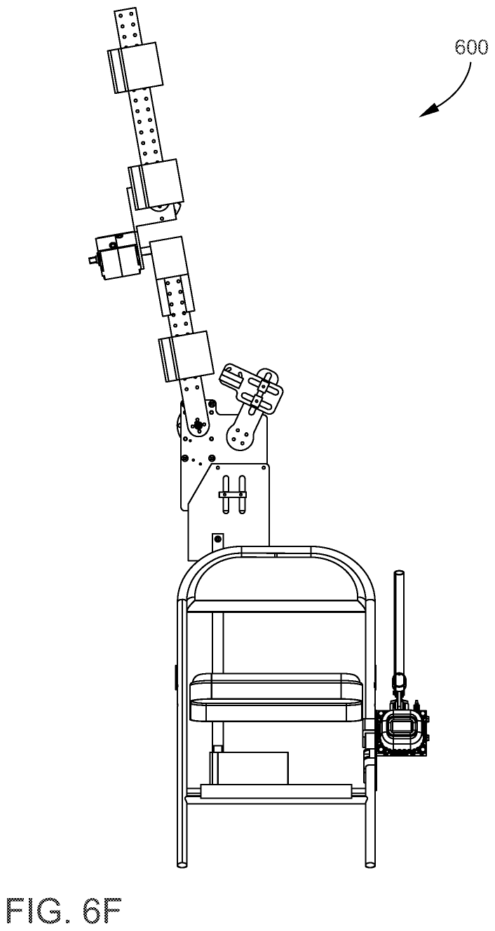

FIGS. 6A-6C illustrate the device 300 in an arm-straight, ninety (90) degree abduction configuration 600. This configuration can, in some treatment regiments, serve as a starting position for abduction movement. FIGS. 6D-6F illustrate the device 300 in an arm-straight, one-hundred seventy (170) degree abduction configuration 602. This configuration can, in some treatment regiments, serve as an ending position for abduction movement. FIGS. 7A-7J illustrate the device 300 in a forward flexion configuration 700 where the support and the arm coupling mechanism 706 are shown in a straight-arm, forward flexion starting position 702. FIGS. 7K-7M illustrate the device 300 in a forward flexion configuration 700 where the support and the arm coupling mechanism 706 are shown in a straight-arm, forward flexion ending position 704.

As shown in FIG. 7E, a lower rotary actuator 710 may provide rotary power to hinge 330, which is operatively coupled to hinge arm 332 and to upright 320 of the device 300. The lower rotary actuator 710 may not only serve to transition the device 300 from a first position wherein the upright 320 is behind the chair to a second position where the upright is to the side of the chair, but the lower rotary actuator 710 may also serve to provide a type of external rotational or internal rotational stretch for the patient when activated. In some embodiments, the device 300 may have a lazy-susan-style hinge arm 332 that is structured to carry the weight of the upright 320 and its attachments as the device is moved from the first position to the second position. In other embodiments, the hinge arm 332 may also include one or more rollers for rolling along the upper surface of the platform for additional weight support or otherwise may be strengthened to support additional weight.

While the device is positioned in the forward flexion configuration as shown in FIG. 7, a combined stretch of forward flexion and then rotation around the axis of the hinge 330 can be applied at variable levels of flexion (i.e. the arm can be straight out in front at 90 degrees of flexion or below or above 90 degrees of flexion). This allows for a unique stretch similar to the external rotation stretch provided by internal/external rotary actuator 318 but with the axis of rotation around the axis of the hinge 330 rather than the axis of the upper arm of the patient as is the case when the rotation happens at the internal/external rotary actuator 318. This combined stretch may provide the necessary stretching in external and internal rotation where the internal/external rotary actuator 318 is not needed or the combined stretch may be additive to the stretch provided by the internal/external rotary actuator 318.

Similarly, while the device is in the abduction position, internal/external rotation around the internal/external rotary actuator 318 could be performed at variable levels of abduction around the abduction rotary actuator 314. The external rotation could be done at 90 degrees of abduction or at another level of abduction (most likely less than 90 degrees).

FIG. 8A illustrates a control mechanism 800 for controlling two actuators that includes a forward-reverse switch 804 and two actuator on-off switches 806. FIG. 8B illustrates a control mechanism 802 for controlling three actuators that includes a forward-reverse switch 804 and three actuator on-off switches 808. Similarly, if four actuators needed to be controlled, four on-off switches could be used, still with two hoses going from the on-off switches to the pump.

FIG. 8C illustrates a block diagram of a control system according to embodiments of the invention. As shown, actuators are connected to the control switches via two hoses each. The control switches determine whether each particular actuator is on or off. Only one actuator is on at a time. The control switches are connected to the pump via two hoses.

In the various embodiments of devices discussed herein and in their corresponding figures, hoses operatively coupling or connecting the several rotary actuators with the pump are not shown in the figures for ease of illustration. It should be understood that the rotary actuators are typically connected by two hoses to the controller, which is connected itself by two hoses to the pump.

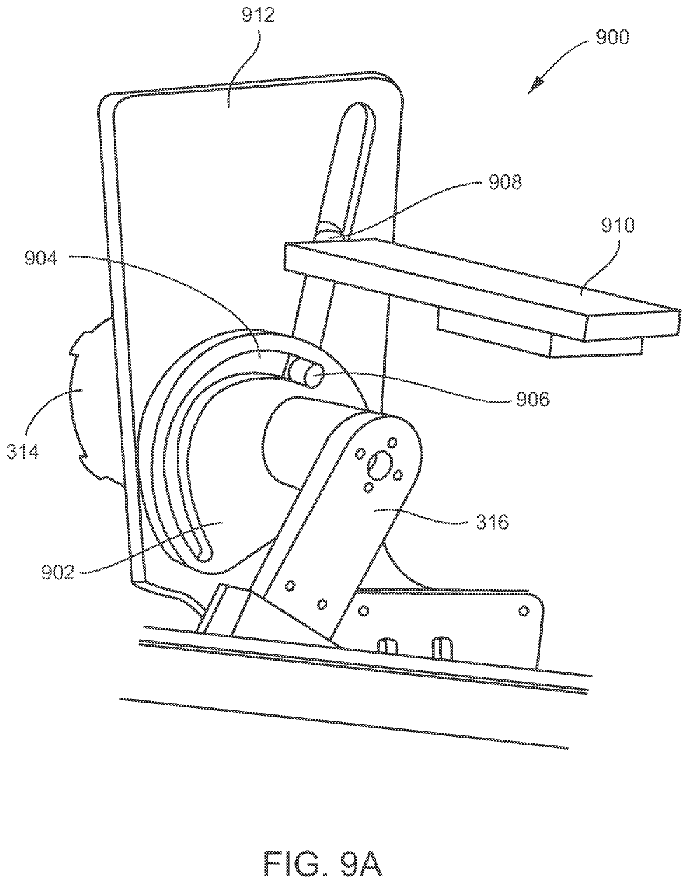

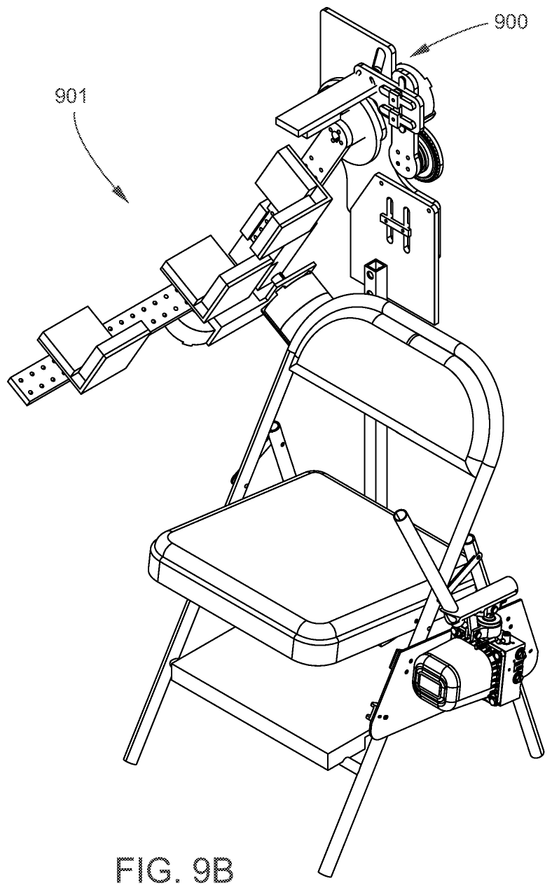

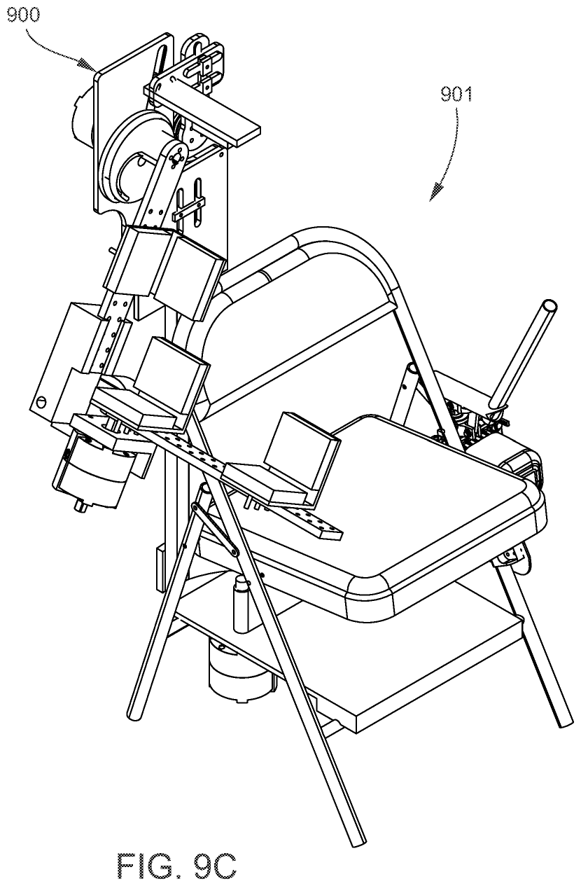

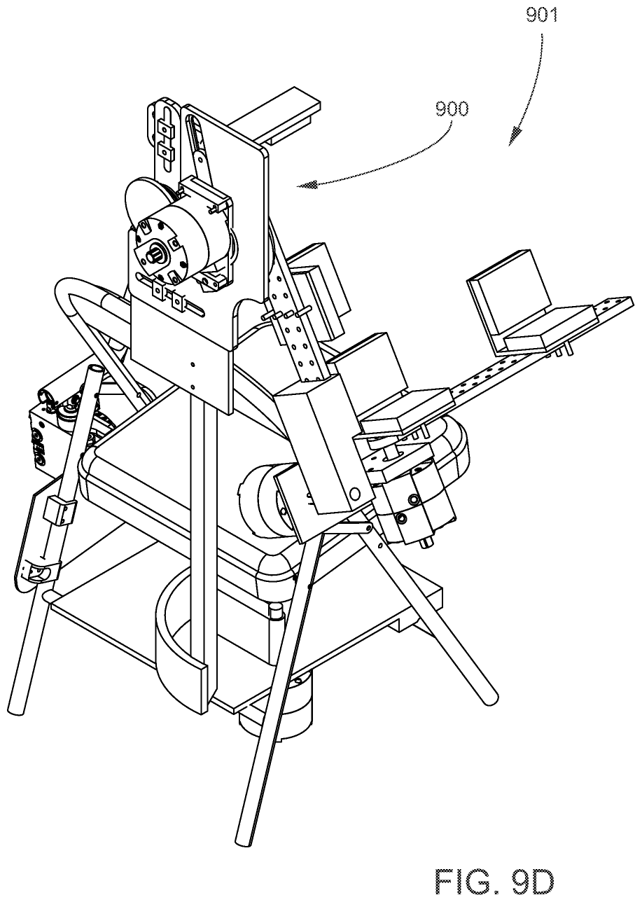

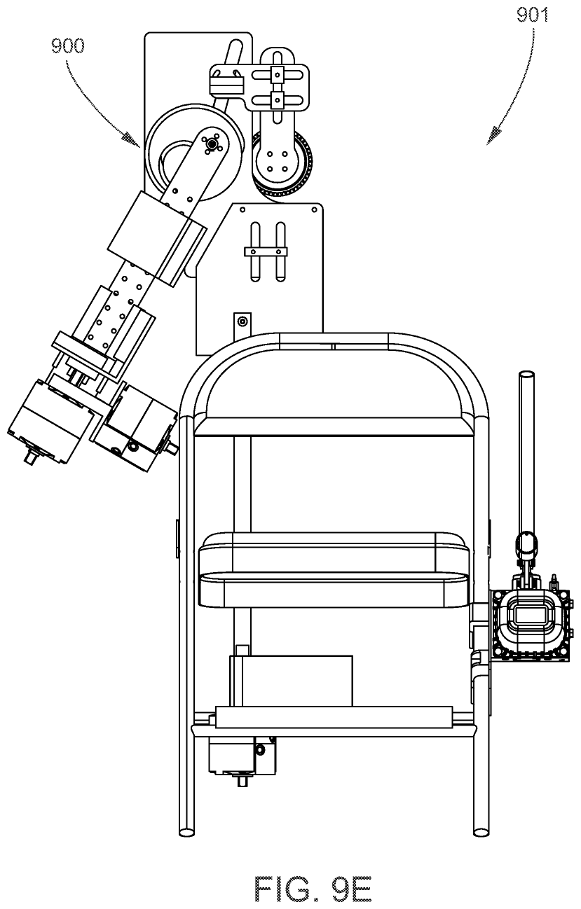

FIGS. 9A-9E illustrate a device 901 according to another embodiment of the invention having a cam mechanism 900 wherein a cam 902 having a channel 904 is rotated by the actuator 314 of the device 901. Follower 906 moves with cam 902's rotation and translates the movement into follower 908 and shoulder pad 910. The cam mechanism is operable coupled to plate 912.

It should be noted that features in all embodiments previously discussed may be used in conjunction with or in place of features in all previous embodiments.

1. A device for manipulating an arm of a user, thereby providing abduction or flexion assistance to a shoulder of the user, the device comprising:
(a) an engagement mechanism configured to operatively couple with the user's arm and configured to pivot about an axis defined by the gleno-humeral joint of the shoulder as the shoulder abducts or flexes;
(b) a scapular restriction mechanism configured to restrict movement of a scapula of the user's shoulder during a first phase of abduction or flexion and to move in an approximately anatomically correct ratio with gleno-humeral motion during a second phase of abduction or flexion; and
(c) a force application system operatively coupled with the engagement mechanism, and configured to apply a force to the engagement mechanism, thereby providing the abduction or flexion assistance to the arm about the shoulder.

2. The device of claim 1, wherein the approximately anatomically correct ratio is approximately 1:2 scapular to gleno-humeral motion during the second phase of abduction or flexion.

3. The device of claim 1, wherein the force application system comprises an abduction rotary actuator configured to apply rotational force to the engagement mechanism to cause the engagement mechanism to move in abduction.

4. The device of claim 1, wherein the force application system comprises an external/internal rotary actuator configured to apply rotational force to the engagement mechanism to cause the engagement mechanism to move in external rotation or internal rotation.

5. The device of claim 1, wherein the force application system comprises a lower rotary actuator configured to apply rotational force to the engagement mechanism to cause the engagement mechanism to move in external rotation or internal rotation.

6. A device for manipulating an arm of a user, thereby providing abduction, forward flexion, external rotation, and internal rotation assistance to a shoulder of the user, the device comprising:
(a) an engagement mechanism configured to operatively couple with the user's arm and configured to pivot about an axis defined by the gleno-humeral joint of the shoulder as the shoulder abducts or flexes;
(b) a chair platform configured to operatively couple with a folding chair;
(c) a swivel hinge operatively coupled with the chair platform; and
(d) an upright operatively coupled with the swivel hinge, wherein the swivel hinge is configured to enable the upright to swivel from a first position wherein the device is configured to enable abduction to a second position wherein the device is configured to enable forward flexion.

7. The device of claim 6, further comprising:
(a) a rotary actuator operatively coupled to the chair platform and configured to apply rotational force to the hinge to cause the device to swivel from the first position to the second position and vice versa as controlled by the user.

8. A method for manipulating a user's arm, thereby providing abduction or flexion assistance to a shoulder of the user, the method comprising:
(a) engaging the arm of the user with an engagement mechanism configured to pivot about an axis defined by the gleno-humeral joint of the shoulder as the arm extends or flexes about the shoulder;
(b) restricting movement of a scapula of the shoulder during a first phase of movement and allowing movement of the scapula during a second phase of movement in an approximately anatomically correct ratio of gleno-humeral motion to scapular motion; and
(c) activating a force application mechanism to apply an incremental force to the engagement mechanism, thereby creating a torque about the axis through the gleno-humeral joint of the shoulder and causing abduction or flexion of the user's arm about the shoulder of the user.

9. The method of claim 8, wherein the approximately anatomically correct ratio is approximately 2:1 gleno-humeral to scapular motion.

10. A method for manipulating an arm of a user, thereby providing abduction, forward flexion, external rotation, and internal rotation assistance to a shoulder of the user using a device having an engagement mechanism configured to operatively couple with the user's arm, the method comprising:
(a) pivoting an arm of the user, using the engagement mechanism, about an axis defined by the gleno-humeral joint of the shoulder as the shoulder abducts or flexes; and
(b) changing the engagement mechanism from a first position wherein the device is configured to enable abduction to a second position wherein the device is configured to enable forward flexion.

11. The method of claim 10, wherein the changing comprises swiveling the engagement mechanism from the first position to the second position.

12. The method claim 11, wherein the swiveling is performed by applying a rotary force using a rotary actuator.

13. The method of claim 10, further comprising:
(a) pivoting an arm of the user in external rotation or internal rotation by applying a rotary force using a rotary actuator.

14. The method of claim 13, wherein the rotary actuator is operatively coupled with a swivel hinge operatively coupled with an upright operatively coupled with the engagement mechanism.

15. The method of claim 13, wherein the rotary actuator is operatively coupled proximate a distal end of an upper arm of the engagement mechanism.

16. The method of claim 11, wherein the swiveling is performed by applying a force using a linear actuator.
